(19) United States
(12) Patent Application Publication
(10) Pub. No.: US 2026/0370545 A1
(43) Pub. Date: Nov. 19, 2026

(54) METHOD AND APPARATUS FOR SUBSCRIPTION AND NOTIFICATION

(71) Applicant: Telefonaktiebolaget LM Ericsson (publ), Stockholm (SE)

(72) Inventors: Tianmei LIANG, Shanghai (CN); Ulf MATTSSON, Kungsbacka (SE); Zhang FU, Stockholm (SE); Antonio INIESTA GONZALEZ, Madrid (ES); Maria Belen PANCORBO MARCOS, Madrid (ES)

(73) Assignee: Telefonaktiebolaget LM Ericsson (publ), Stockholm (SE)

(21) Appl. No.: 19/145,739

(22) PCT Filed: Jan. 4, 2024
(86) PCT No.: PCT/CN2024/070558

§ 371 Date: Jul. 3, 2025

(30) Foreign Application Priority Data
Jan. 4, 2023 (WO) PCT/CN2023/070417

(51) Int. Cl. H04L 41/0686

(52) U.S. Cl. CPC H04L 41/0686

(57) ABSTRACT

Embodiments of the present disclosure provide method and apparatus for subscription and notification. A method performed by a first NF comprises receiving a first notification message or a first unsubscription response comprising pending notification data from a third NF. The first notification message may further comprise second information indicating a cause of notification of the pending notification data.

### TECHNICAL FIELD

The non-limiting and exemplary embodiments of the present disclosure generally relate to the technical field of communications, and specifically to methods and apparatuses for subscription and notification.

### BACKGROUND

This section introduces aspects that may facilitate a better understanding of the disclosure. Accordingly, the statements of this section are to be read in this light and are not to be understood as admissions about what is in the prior art or what is not in the prior art.

In a network, the network capability exposure may be required in various scenarios. For example, the network capability exposure may comprise exposure of network events externally as well as internally towards core network functions (NFs), exposure of provisioning capability towards external functions, exposure of policy and charging capabilities towards external functions, exposure of core network internal capabilities for analytics, exposure of analytics to external party, retrieval of data from external party by network data analytics function, exposure of number of registered user equipments (UEs) and/or established protocol data unit (PDU) sessions for a network slice that is subject to network slice admission control towards core network NFs or external party, etc.

The Subscribe-Notify mechanisms may be used for network capability exposure. For example, the Subscribe-Notify mechanisms are described in various 3GPP (Third Generation Partnership Project) specifications such as 3GPP TS 23.501 V18.0.0, 3GPP TS 23.502 V18.0.0, 3GPP TS 23.288 V18.0.0, 3GPP TR 23.700-81 V18.0.0, the disclosure of which is incorporated by reference herein in its entirety.

When subscribing to event reporting, the event consumer NF may provide e.g., one or multiple event identifiers (IDs), event filter information, event reporting information, target of event reporting, a notification target address (+Notification Correlation ID) allowing the Event Receiving NF to correlate notifications received from the event provider with this subscription, an expiry time represents the time up to which the subscription is desired to be kept as active, etc.

When the subscription is accepted by the event provider NF, the event consumer NF may receive from the event provider NF an event notification message.

For example, NWDAF (Network Data Analytics Function) may provide Nnwdaf_AnalyticsSubscription service which may support the analytics consumer NF to include analytics parameters covering the event reporting information in the analytics event(s) subscription, to request the NWDAF to handle the corresponding analysis event(s) and notify the analytics event upon the required triggering condition.

For example, NWDAF, DCCF (Data Collection Coordination) and ADRF (Analytics Data Repository Function) support data management subscription for notification and may include processing instructions in the subscription request.

Table 1 shows an example of event reporting information, which is same as Table 4.15.1-1 of 3GPP TS 23.502 V18.0.0, the disclosure of which is incorporated by reference herein in its entirety.

TABLE 1
Event Reporting Information

| Event Reporting Information | | Presence |
|---|---|---|
| Parameter | Description | requirement |
| Event reporting mode | Mode of reporting - e.g. reporting up to a maximum number of | mandatory |
| | reports, periodic reporting along with periodicity, reporting up | |
| | to a maximum duration, reporting when threshold is reached | |
| Maximum number of reports | Maximum number of reports after which the event | (see NOTE 1) |
| | subscription ceases to exist | |
| Maximum duration of reporting | Maximum duration after which the event subscription ceases | (see NOTE 1) |
| | to exist | |
| Immediate reporting flag | The Event provider NF notifies the current status of the | |
| | subscribed event, if available, immediately to the consumer | |
| | NF. | |
| Sampling ratio | Percentage of sampling (1% . . . 100%) among impacted UEs. | optional |
| | | (see NOTE 2) |
| Partitioning criteria | Criteria for partitioning UEs before applying sampling ratio. | optional |
| | | (see NOTE 2) |
| Group Reporting Guard Time | Parameter for group-based monitoring configuration to | optional |
| | indicate the time for which the Monitoring Event Reporting(s) | |
| | related with the UEs in a group can be aggregated before | |
| | sending them to the consumer NF. | |
| Deactivate notification flag | Indicates to the Event provider NF that the notification of the | optional |
| | available events shall be muted until the Event consumer NF | |
| | provides the retrieval notification flag to retrieve the events | |
| | stored. | |
| Retrieval notification flag | Indicates to the Event provider NF to send the notification to | optional |
| | the Event consumer NF with the stored events and mutes again | |
| | the notification of future events. | |
| Granularity of dynamics | The maximum amount of dynamics in the event which allows | optional |
| | to skip an event notification. | (see NOTE 3) |
| Reporting type | Event provider NF reports only when the events differs from | optional |
| | the previously notified event. | (see NOTE 4) |
| Reporting Threshold | Threshold values indicate conditions on the level to be reached | Optional |
| | for the reporting | (see NOTE 5) |

(NOTE 1):
The requester shall include 2) Maximum number of reports or 3) Maximum duration of reporting, or both, depending on 1) Event reporting mode.
(NOTE 2):
Parameter only applicable to certain event IDs reporting metrics (e.g. Number of UEs present in a geographical area) used and used e.g. by the NWDAF for data collection.
(NOTE 3):
The Granularity of dynamics includes 1) the range of scalar value, 2) the list of events identification, or 3) the previous notification. The range of scalar value is only applicable to the event depicted as number (e.g. the number of UE), the others is applicable to the event depicted as identification (e.g. UE location, UE identification).
(NOTE 4):
The differences in event includes the events have been newly appeared, disappeared and changed from the previous notification.
(NOTE 5):
This parameter is included only if the Event reporting mode indicates reporting when threshold is reached.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There are some problems for the existing Subscribe-Notify mechanisms.

For example, there may be stored unsent event(s) before a notification triggering condition is met in some scenarios, e.g., the aggregation NF (e.g., NWDAF), bulk data handling, subscription (e.g., analytic subscription) transfer or NF (e.g., DCCF) relocation, etc. If an exception occurs, e.g., the NF (e.g., NWDAF) cannot handle the event data or analytics anymore, the NF (e.g., DCCF) cannot handle the data any more, the unsubscription request is received from the event (analytics) consumer NF, or the NF (e.g., NWDAF/DCCF) decides to send a termination request, etc., there may be several issues as below e.g. in Nnwdaf_AnalyticsSubscription_Subscribe, Nnwdaf_DataManagement_Subscribe and/or Ndccf_DataManagement_Subscribe service operations:
No specification on how to handle the pending stored event(s) upon an occurrence of an exception, e.g. NWDAF pending analytics event(s), or NWDAF/DCCF data management pending data event(s),
If the exception case is e.g. unsubscription request received e.g. from the event consumer NF, the unsubscription response message provided by the event producer NF cannot support the handling of the pending stored event(s) notification, or
The service consumer NF cannot indicate the requirement on how to handle such stored unsent event(s) upon an exception occurs.

To overcome or mitigate at least one of above mentioned problems or other problems, the embodiments of the present disclosure propose an improved solution for subscription and notification.

In a first aspect of the disclosure, there is provided a method performed by a first network function (NF). The method comprises receiving a first notification message or a first unsubscription response comprising pending notification data from a third NF.

In an embodiment, the first notification message may further comprise second information indicating a cause of notification of the pending notification data.

In an embodiment, the first notification message may further comprise information notifying a consumer instance when data or analytics is to be deleted.

In an embodiment, the method may further comprise sending, to the third NF, a first notification response message comprising information indicating if the consumer instance will retrieve stored data or analytics prior to deletion.

In an embodiment, the method may further comprise sending a second notification message or a second unsubscription response comprising the pending notification data to a second NF.

In an embodiment, the second notification message may further comprise the second information indicating the cause of notification of the pending notification data.

In an embodiment, the second notification message further comprises information notifying a consumer instance when data or analytics is to be deleted.

In an embodiment, the method may further comprise receiving, from the second NF, a second notification response message comprising information indicating if the consumer instance will retrieve stored data or analytics prior to deletion.

In an embodiment, the first NF and/or the second NF may comprise at least one of an analytics data repository function (ADRF), an aggregator NWDAF, a data collection coordination (DCCF), a network data analytics function (NWDAF), a network exposure function (NEF), an access and mobility management function (AMF), a session management function (SMF), a unified data management (UDM), a network slice admission control function (NSACF), an application function (AF), a policy control function (PCF), or a user plane function (UPF).

In an embodiment, the cause of notification of the pending notification data may comprise at least one of an exception occurs in the event producer NF, the event producer NF cannot handle analytics, the event producer NF cannot handle event data, the event producer NF receives an unsubscription request, the event producer NF decides to send a termination request, event data cannot be collected, subscription is transferred, DCCF cannot handle the analytics data or collected data, or aggregator NWDAF cannot handle the analytics.

In an embodiment, the notification message may comprise at least one of a data management notification message, an analytics subscription notification message, or an event exposure notification message.

In an embodiment, the notification message may comprise a termination request.

In an embodiment, the third NF may comprise at least one of an analytics data repository function (ADRF), an aggregator NWDAF, a data collection coordination (DCCF), a network data analytics function (NWDAF), a network exposure function (NEF), an access and mobility management function (AMF), a session management function (SMF), a unified data management (UDM), a network slice admission control function (NSACF), an application function (AF), a policy control function (PCF), or a user plane function (UPF).

In a second aspect of the disclosure, there is provided a method performed by a second NF. The method may comprise sending a first notification message or a first unsubscription response comprising pending notification data to a first NF.

In an embodiment, the first notification message may further comprise second information indicating a cause of notification of the pending notification data.

In an embodiment, the first notification message may further comprise information notifying a consumer instance when data or analytics is to be deleted.

In an embodiment, the method may further comprise receiving, from the first NF, a first notification response message comprising information indicating if the consumer instance will retrieve stored data or analytics prior to deletion.

In an embodiment, the first NF may comprise at least one of an analytics data repository function (ADRF), an aggregator NWDAF, a data collection coordination (DCCF), a network data analytics function (NWDAF), a network exposure function (NEF), an access and mobility management function (AMF), a session management function (SMF), a unified data management (UDM), a network slice admission control function (NSACF), an application function (AF), a policy control function (PCF), or a user plane function (UPF).

In an embodiment, the cause of notification of the pending notification data may comprise at least one of an exception occurs in the event producer NF, the event producer NF cannot handle analytics, the event producer NF cannot handle event data, the event producer NF receives an unsubscription request, the event producer NF decides to send a termination request, event data cannot be collected, subscription is transferred, DCCF cannot handle the analytics data or collected data, or aggregator NWDAF cannot handle the analytics.

In an embodiment, the notification message may comprise at least one of a data management notification message, an analytics subscription notification message, or an event exposure notification message.

In an embodiment, the notification message may comprise a termination request.

In an embodiment, the third NF may comprise at least one of an analytics data repository function (ADRF), an aggregator NWDAF, a data collection coordination (DCCF), a network data analytics function (NWDAF), a network exposure function (NEF), an access and mobility management function (AMF), a session management function (SMF), a unified data management (UDM), a network slice admission control function (NSACF), an application function (AF), a policy control function (PCF), or a user plane function (UPF).

In a third aspect of the disclosure, there is provided a first NF. The first NF comprises a processor and a memory coupled to the processor. Said memory contains instructions executable by said processor. Said first NF is operative to receive a first notification message or a first unsubscription response comprising pending notification data from a third NF. The first notification message may further comprise second information indicating a cause of notification of the pending notification data.

In a fourth aspect of the disclosure, there is provided a third NF. The third NF comprises a processor and a memory coupled to the processor. Said memory contains instructions executable by said processor. Said third NF is operative to send a first notification message or a first unsubscription response comprising pending notification data to a first NF. The first notification message may further comprise second information indicating a cause of notification of the pending notification data.

In a fifth aspect of the disclosure, there is provided a first NF. The first NF comprises a first receiving module configured to receive a first notification message or a first unsubscription response comprising pending notification data from a third NF. The first notification message may further comprise second information indicating a cause of notification of the pending notification data.

In an embodiment, the first NF may further comprise a first sending module configured to send, to the third NF, a first notification response message comprising information indicating if the consumer instance will retrieve stored data or analytics prior to deletion.

In an embodiment, the first NF may further comprise a second sending module configured to send a second notification message or a second unsubscription response comprising the pending notification data to a second NF. The second notification message may further comprise the second information indicating the cause of notification of the pending notification data.

In an embodiment, the first NF may further comprise a second receiving module configured to receive, from the second NF, a second notification response message comprising information indicating if the consumer instance will retrieve stored data or analytics prior to deletion.

In a sixth aspect of the disclosure, there is provided a third NF. The third NF comprises a sending module configured to send a first notification message or a first unsubscription response comprising pending notification data to a first NF. The first notification message may further comprise second information indicating a cause of notification of the pending notification data.

In an embodiment, the third NF may further comprise a receiving module configured to receive, from the first NF, a first notification response message comprising information indicating if the consumer instance will retrieve stored data or analytics prior to deletion.

In a seventh aspect of the disclosure, there is provided a computer program product comprising instructions which when executed by at least one processor, cause the at least one processor to perform the method according to any one of the first or second aspects.

In an eighth aspect of the disclosure, there is provided a computer-readable storage medium storing instructions which when executed by at least one processor, cause the at least one processor to perform the method according to any one of the first or second aspects.

Embodiments herein may provide many advantages, of which a non-exhaustive list of examples follows. In some embodiments herein, the pending notification data (such as collection event) can avoid losing notifications from NF (such as NWDAF/DCCF) upon some exception occurs. In some embodiments herein, it supports enhancement (e.g. NWDAF) on related more complete and much accurate analytics handling. In some embodiments herein, the pending notification data (such as analytics event) can enhance the analytics consumer on related more complete and much accurate analytics output based actions. In some embodiments herein, the added “pending notification flag” in the Event Reporting Information table and the usage description in clause 4.15.1 of TS 23.502 v18.0.0 can also be commonly utilized by other NF event(s) exposure case with stored unsent event(s) upon an exception occurs to complete and enhance the exceptional event(s) reporting and aligned handling with the exception cases. In some embodiments herein, flexible pending notification handle is proposed. In some embodiments herein, it may enable the event consumer NF to indicate the event producer NF action on how to handle the stored unsent event(s) upon an exception occurs. In some embodiments herein, it may enable the event producer NF to effectively handle the pending notification before handling an exception. In some embodiments herein, it may enable flexible pending notification messaging to minimize the handling impacts. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a schematically shows a high level architecture in the fifth generation network according to an embodiment of the present disclosure;

FIG. 1b schematically shows a data collection architecture using data collection coordination according to an embodiment of the present disclosure;

FIG. 1c schematically shows a network data analytics exposure architecture using data collection coordination according to an embodiment of the present disclosure;

FIG. 1d schematically shows a data storage architecture for analytics and collected data according to an embodiment of the present disclosure;

FIG. 2a shows a flowchart of a first example of Subscribe-Notify NF Service according to an embodiment of the present disclosure;

FIG. 2b shows a flowchart of a second example of Subscribe-Notify NF Service according to an embodiment of the present disclosure;

FIG. 2c shows a flowchart of Subscribe-Notify using indirect communication according to an embodiment of the present disclosure;

FIG. 3a shows a flowchart of a method according to an embodiment of the present disclosure;

FIG. 3b shows a flowchart of a method according to another embodiment of the present disclosure;

FIG. 3c shows a flowchart of a method according to another embodiment of the present disclosure;

FIG. 3d shows a flowchart of a method according to another embodiment of the present disclosure;

FIG. 3e shows a flowchart of a method according to another embodiment of the present disclosure;

FIG. 3f shows a flowchart of a method according to another embodiment of the present disclosure;

FIG. 3g shows a flowchart of a method according to another embodiment of the present disclosure;

FIG. 3h shows a flowchart of a method according to another embodiment of the present disclosure;

FIG. 4a shows a flowchart of a method according to another embodiment of the present disclosure;

FIG. 4b shows a flowchart of a method according to another embodiment of the present disclosure;

FIG. 4c shows a flowchart of a method according to another embodiment of the present disclosure;

FIG. 4d shows a flowchart of a method according to another embodiment of the present disclosure;

FIG. 5 shows a flowchart of a method according to another embodiment of the present disclosure;

FIG. 6a shows a flowchart of a Subscribe-Notify method according to another embodiment of the present disclosure;

FIG. 6b shows a flowchart of a Subscribe-Notify method according to another embodiment of the present disclosure;

FIG. 7a shows a flowchart of a Subscribe-Notify method according to another embodiment of the present disclosure;

FIG. 7b shows a flowchart of a Subscribe-Notify method according to another embodiment of the present disclosure;

FIG. 8a is a block diagram showing an apparatus suitable for practicing some embodiments of the disclosure;

FIG. 8b is a block diagram showing a first NF according to an embodiment of the disclosure;

FIG. 8c is a block diagram showing a second NF according to an embodiment of the disclosure; and

FIG. 8d is a block diagram showing an event consumer NF according to an embodiment of the disclosure;

FIG. 8e is a block diagram showing a first NF according to another embodiment of the disclosure; and

FIG. 8f is a block diagram showing a third NF according to another embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” or “network function” refers to any suitable function which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), network data analytics function (NWDAF), data collection coordination (DCCF), analytics data repository function (ADRF), gateway mobile location center (GMLC), network slice admission control function (NSACF), etc. For example, the 4G system (such as LTE (Long Term Evolution)) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” may be understood to mean “only A, only B, or both A and B.” The phrase “A and/or B” may be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

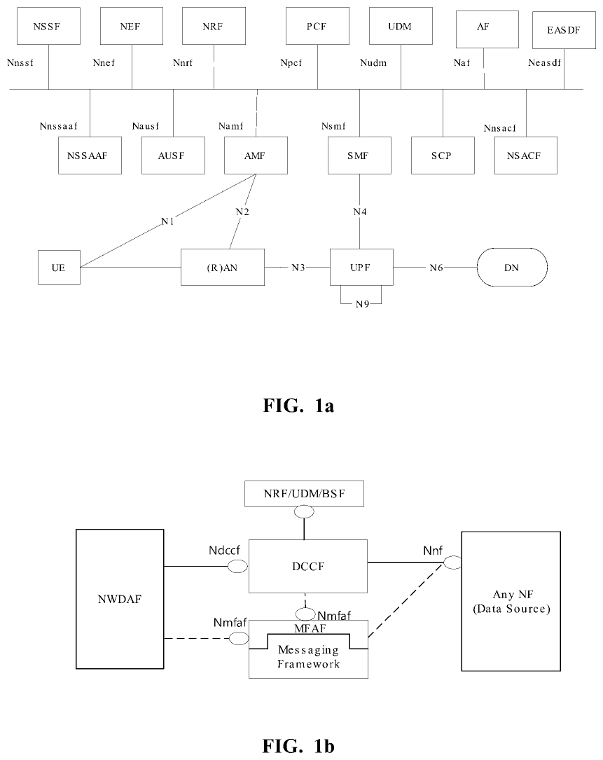

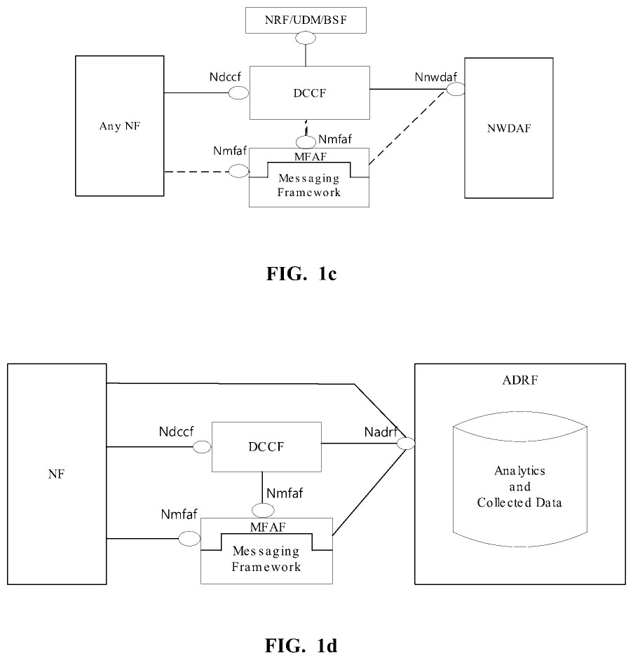

Although the subject matter described herein may be implemented in any appropriate type of system using any suitable components, the embodiments disclosed herein are described in relation to a communication system complied with the exemplary system architecture illustrated in FIGS. 1a, 1b, 1c and 1d. For simplicity, the system architectures of FIGS. 1a, 1b, 1c and 1d only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

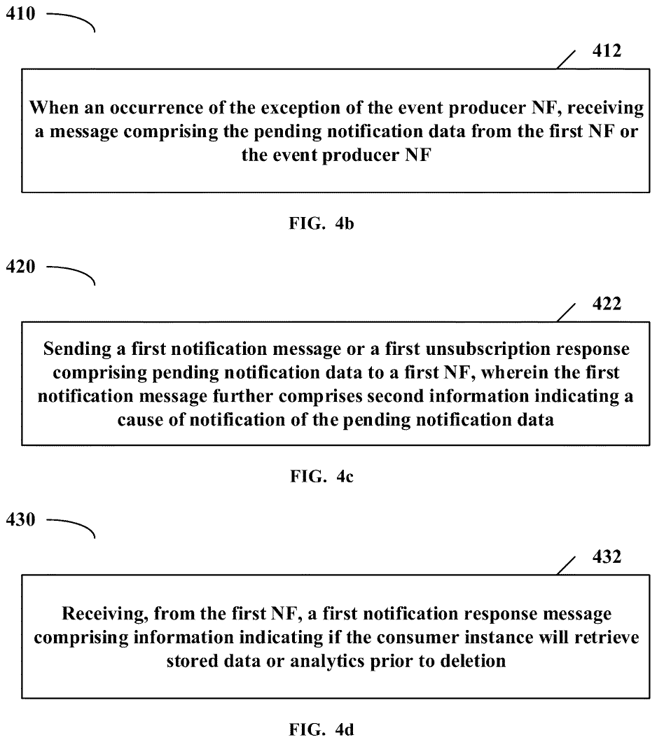

FIG. 1a schematically shows a high level architecture in the fifth generation network according to an embodiment of the present disclosure. For example, the fifth generation network may be 5GS. The architecture of FIG. 1a is same as FIG. 4.2.3-1 of 3GPP TS 23.501 V18.0.0. The system architecture of FIG. 1a may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), NSACF (Network Slice Admission Control Function), Edge Application Server Discovery Function (EASDF), etc.

In accordance with an exemplary embodiment, the UE can establish a signaling connection with the AMF over the reference point N1, as illustrated in FIG. 1a. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 1a, the exemplary system architecture also contains the service-based interfaces such as Nnrf, Nnef, Nausf, Nudm, Npcf, Namf, Nnsacf, Neasdf and Nsmf exhibited by NFs such as the NRF, the NEF, the AUSF, the UDM, the PCF, the AMF, the NSACF, the EASDF and the SMF. In addition, FIG. 1a also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

FIG. 1b schematically shows a data collection architecture using data collection coordination according to an embodiment of the present disclosure. The architecture of FIG. 1b is same as FIG. 4.2.0-1a of 3GPP TS 23.288 V18.0.0. The system architecture of FIG. 1b may comprise some exemplary elements such as NWDAF, DCCF, MFAF (Messaging Framework Adaptor Function), NRF/UDM/BSF (Binding Support Function) and any NF (data source).

As depicted in FIG. 1b, the Ndccf interface is defined for the NWDAF to support subscription request(s) for data delivery from a DCCF, to cancel subscription to data delivery and to request a specific report of data. If the data is not already being collected, the DCCF requests the data from the data source using Nnf services. The DCCF may collect the data and deliver it to the NWDAF or the DCCF may rely on a messaging framework to collect data from the NF and deliver it to the NWDAF.

FIG. 1c schematically shows a network data analytics exposure architecture using data collection coordination according to an embodiment of the present disclosure. The architecture of FIG. 1c is same as FIG. 4.2.0-2a of 3GPP TS 23.288 V18.0.0. The system architecture of FIG. 1c may comprise some exemplary elements such as NWDAF, DCCF, MFAF, NRF/UDM/BSF and any NF.

As depicted in FIG. 1c, the Ndccf interface is defined for any NF to support subscription request(s) to network analytics, to cancel subscription for network analytics and to request a specific report of network analytics. If the analytics is not already being collected, the DCCF requests the analytics from the NWDAF using Nnwdaf services. The DCCF may collect the analytics and deliver it to the NF, or the DCCF may rely on a messaging framework to collect analytics and deliver it to the NF.

FIG. 1d schematically shows a data storage architecture for analytics and collected data according to an embodiment of the present disclosure. The architecture of FIG. 1d is same as FIG. 4.2.1-1 of 3GPP TS 23.288 V18.0.0. The system architecture of FIG. 1d may comprise some exemplary elements such as ADRF, DCCF, MFAF and NF.

As depicted in 3GPP TS 23.288 V18.0.0, the 5G system architecture allows ADRF to store and retrieve the collected data and analytics. ADRF exposes the Nadrf service for storage and retrieval of data by other 5GC NFs (e.g. NWDAF) which access the data using Nadrf services. Based on the NF request or configuration on the DCCF, the DCCF may determine the ADRF and interact directly or indirectly with the ADRF to request or store data. The consumer NF may use Nadrf_DataManagement_RetrievalSubscribe service operation to retrieve stored data or analytics from the ADRF and to receive future notifications containing the corresponding data or analytics received by ADRF.

Various NFs shown in FIG. 1a, 1b, 1c and 1d may include the corresponding functionality for example as defined in various 3GPP specifications such as 3GPP TS 23.501 V18.0.0, 3GPP TS 23.502 V18.0.0, 3GPP TS 23.503 V18.0.0 and 3GPP TS 23.288 V18.0.0.

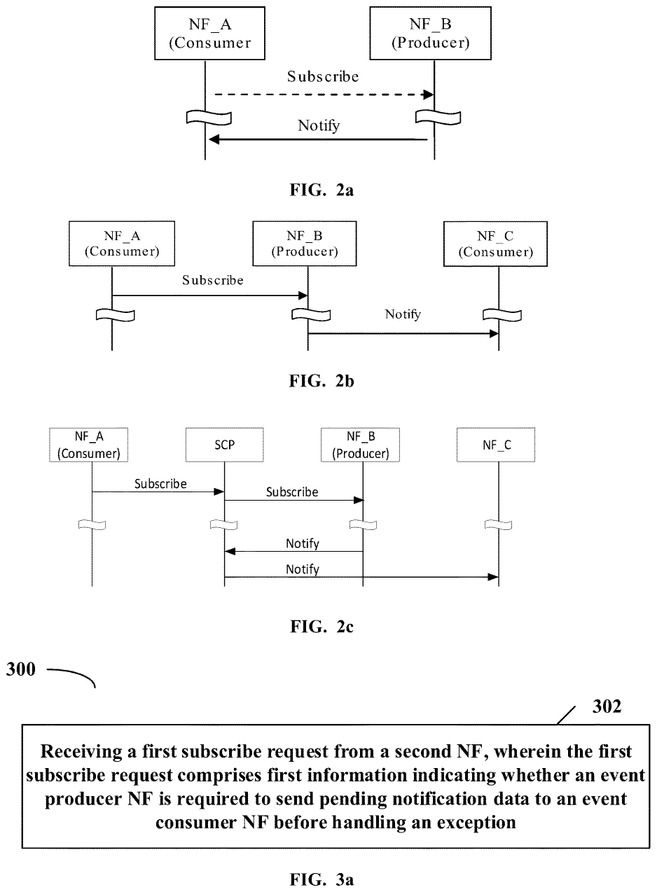

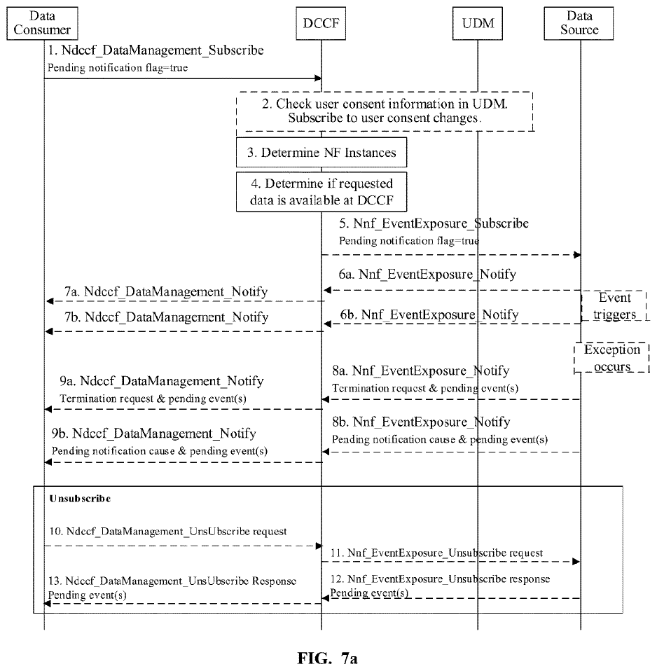

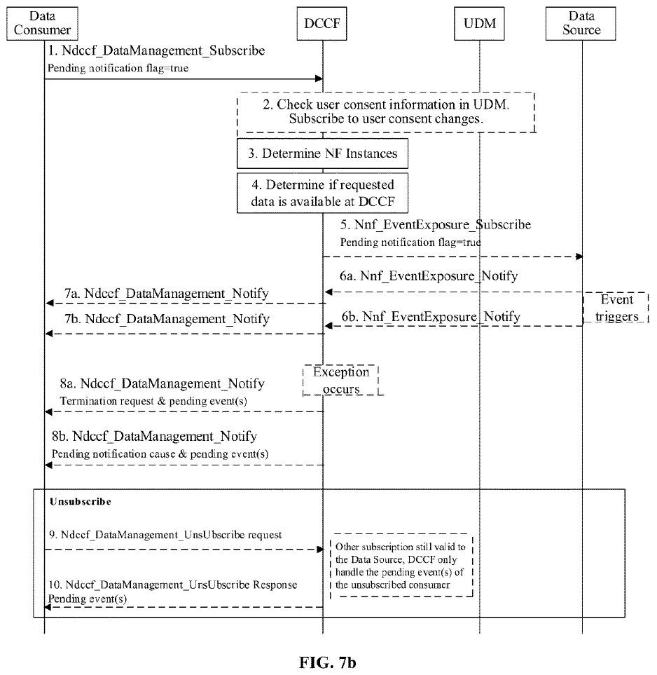

FIG. 2a shows a flowchart of a first example of Subscribe-Notify NF Service according to an embodiment of the present disclosure, which is same as FIG. 7.1.2-2 of 3GPP TS 23.501 V18.0.0.

An NF_A may subscribe to NF Service offered by an NF_B by sending a subscribe request to the NF_B. The NF_B may acknowledge the execution of subscribe request. The NF_B may detect a monitored event occurs and send an event report by means of a notify message to the NF_A.

FIG. 2b shows a flowchart of a second example of Subscribe-Notify NF Service according to an embodiment of the present disclosure, which is same as FIG. 7.1.2-3 of 3GPP TS 23.501 V18.0.0

A NF_A may also subscribe to NF Service offered by NF_B on behalf of NF_C, i.e. it requests the NF Service Producer to send the event notification to another consumer(s). In this case, NF_A includes the notification endpoint, i.e. Notification Target Address and a Notification Correlation ID, of the NF_C in the subscription request. NF_A may also additionally include the notification endpoint and a Notification Correlation ID of NF_A associated with subscription change related Event ID(s), e.g. Subscription Correlation ID Change, in the subscription request, so that NF_A can receive the notification of the subscription change related event.

FIG. 2c shows a flowchart of Subscribe-Notify using indirect communication according to an embodiment of the present disclosure, which is same as FIG. 7.1.2-5 of 3GPP TS 23.501 V18.0.0.

In the case of indirect communication, an SCP is employed by the NF service consumer (NF_A). The SCP routes messages between the NF service consumer (NF_A) and the NF service producer (NF_B) based on the routing binding indication if available, and may do discovery and associated selection of the NF service producer (NF_B) on behalf of a NF service consumer (NF_A). The NF service consumer (NF_A) may request the NF Service Producer (NF_B) to send the event notification to the NF service consumer (NF_A) or another consumer (NF_C) via SCP.

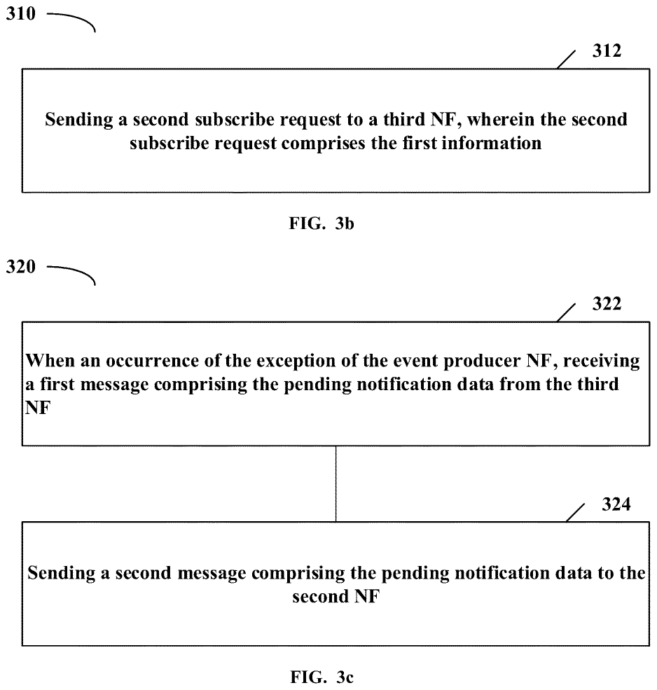

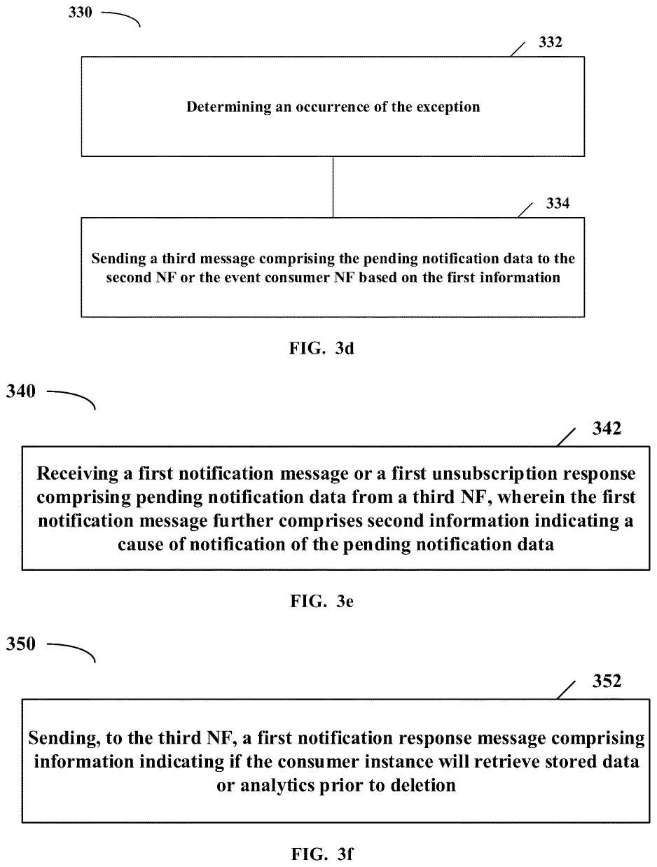

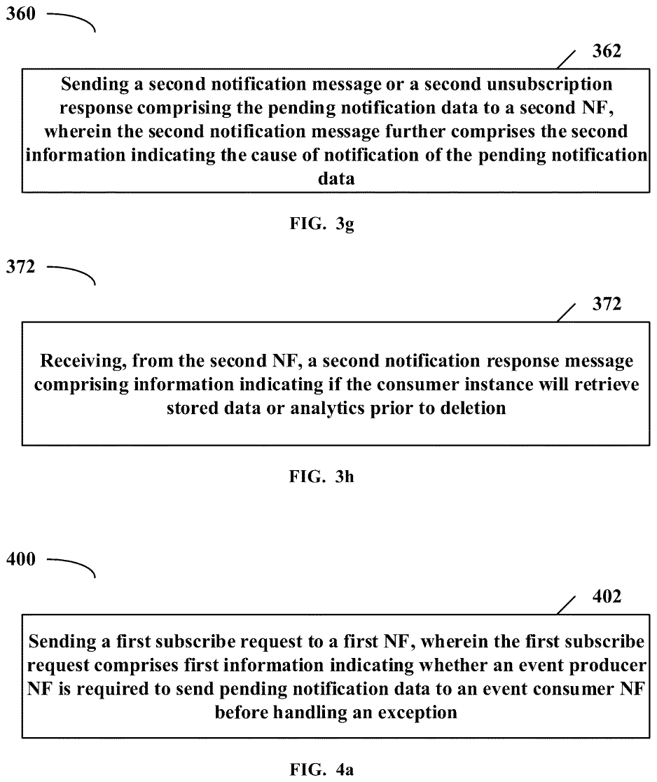

FIG. 3a shows a flowchart of a method according to an embodiment of the present disclosure, which may be performed by an apparatus implemented in or at or as a first network function (NF) or communicatively coupled to the first NF. As such, the apparatus may provide means or modules for accomplishing various parts of the method 300 as well as means or modules for accomplishing other processes in conjunction with other components.

At block 302, the first NF may receive a first subscribe request from a second NF. The first subscribe request may comprise first information indicating whether an event producer NF is required to send pending notification data to an event consumer NF before handling an exception.

The first NF, the second NF, the event producer NF and the event consumer NF may be any suitable network device or node or entity or function. For example, the first NF, the second NF, the event producer NF and the event consumer NF may be any of NFs as defined in various 3GPP specifications such as 3GPP TS 23.501 V18.0.0, 3GPP TS 23.503 V18.0.0 and 3GPP TS 23.288 V18.0.0.

In an embodiment, the second NF may be DCCF service consumer, NWDAF service consumer or data consumer.

In an embodiment, the first NF may be DCCF, NWDAF or data source.

In an embodiment, the first NF may comprise at least one of an ADRF, an aggregator NWDAF, a DCCF, an NWDAF, an NEF, an AMF, a SMF, a UDM, a GMLC, a NSACF, an AF, a SCP, a PCF, or a UPF.

In an embodiment, the second NF may comprise at least one of an ADRF, an aggregator NWDAF, a DCCF, an NWDAF, an NEF, an AMF, a SMF, a UDM, a GMLC, a NSACF, an AF, a SCP, a PCF, or a UPF.

In an embodiment, the event producer NF may comprise at least one of an ADRF, an aggregator NWDAF, a DCCF, an NWDAF, an NEF, an AMF, a SMF, a UDM, a GMLC, a NSACF, an AF, a SCP, a PCF, or a UPF.

In an embodiment, the event consumer NF may comprise at least one of an ADRF, an aggregator NWDAF, a DCCF, an NWDAF, an NEF, an AMF, a SMF, a UDM, a GMLC, a NSACF, an AF, a SCP, a PCF, or a UPF.

The first subscribe request may be any suitable subscribe request such as exiting subscribe request or new subscribe request. In an embodiment, the first subscribe request may be any suitable subscribe request as defined in various 3GPP specifications such as 3GPP TS 23.502 V18.0.0, 3GPP TS 23.503 V18.0.0 and 3GPP TS 23.288 V18.0.0.

In an embodiment, the first subscribe request may comprise at least one of a data management subscribe request such as Ndccf_DataManagement_Subscribe request, an analytics subscribe request such as Nnwdaf_AnalyticsSubscription_Subscribe request, or an event exposure subscribe request.

For example, the first subscribe request may comprise at least one of
Nnwdaf_AnalyticsSubscription_Subscribe request,
Namf_EventExposure_Subscribe request,
Nadrf_DataManagement_RetrievalSubscribe request,
Npcf_PolicyAuthorization_Subscribe request,
Nudm_SDM_Subscribe request,
Ndccf_DataManagement_Subscribe request,
Naf_EventExposure_Subscribe request,
Nsmf_EventExposure_Subscribe request,
Nnwdaf_MLModelProvision_Subscribe request,
Nnsacf_SliceEventExposure_Subscribe request,
Nnef_EventExposure_Subscribe request,
Nnef_AnalyticsExposure_Subscribe request,
Nnwdaf_DataManagement_Subscribe request,
Nmfaf_3caDataManagement subscribe request,
Nadrf_DataManagement_StorageSubscriptionRequest,
Namf_Communication_NIN2MessageSubscribe request,
Namf_Communication_N2InfoSubscribe request,
Namf_Communication_AMFStatusChangeSubscribe request,
Namf_Communication_NonUeN2InfoSubscribe request,
Nudm_EventExposure_Subscribe request,
Npcf_EventExposure_Subscribe request,
Npcf_AMPolicyAuthorization_Subscribe request,
Nnef_AMPolicyAuthorization_Subscribe request,
Nnef_TimeSynchronization_CapsSubscribe request,
Nudr_DM_Subscribe request,
Nbsf_Management_Subscribe request,
Nudsf_UnstructuredDataManagement_Subscribe request,
Nnssf_NSSAIAvailability_Subscribe request,
Nucmf_UECapabilityManagement_Subscribe request,
Nupf_EventExposure_Subscribe request,
Ntsctsf_TimeSynchronization_CapsSubscribe request, or
Ntsctsf_QoSandTSCAssistance_Subscribe request, etc. as defined in 3GPP TS 23.502 V18.0.0 and 3GPP TS 23.288 V18.0.0.

The first subscribe request may comprise any suitable information. For example, the first subscribe request may comprise Event Reporting Information of Table 4.15.1-1.

In an embodiment, the first information may indicate to the event provider NF to send the pending notification to the event consumer NF with the stored unsent event(s) before handling an exception e.g. the unsubscription request is received, the Event provider NF decides to send a termination request, the event subscription is transferred, or the bulk or aggregation handling of event data cannot be processed any now etc.

The first information may be of any suitable form such as a bit, a flag, an indicator, etc. In an embodiment, the first information may comprise a pending notification flag. Note that any other suitable name may be possible.

For example, the pending notification flag may enable to require the event producer NF to send the pending notification of stored unsent event(s) before handling an exception (e.g. the unsubscription request is received, or the event producer NF decides to send terminate request, the event subscription is transferred, or the bulk or aggregation handling of event data cannot be processed any now etc.).

In an embodiment, when the pending notification flag is set as true, it may indicate that the event producer NF is required to send the pending notification data to the event consumer NF before handling the exception.

For example, when the pending notification flag is set as true, the event producer NF may send the pending notification of the stored unsent event(s) before handling an exception. The pending notification can be included in at least one of:
in the same notification message if the event produce NF decides to send terminate request notification to the event consumer NF;
in the unsubscription response if the event consumer NF itself is the notification end point; or
in a separate notification message contains the pending notification cause before the exception handling.

In an embodiment, when the pending notification flag is set as false or not present, it indicates that the event producer NF is not required to send the pending notification data to the event consumer NF before handling the exception.

For example, when the pending notification flag is set as false or not present, the event producer NF needn't send the pending notification and may discard the stored unsent event(s) e.g. if they cannot be handled upon the exception. Alternatively, the event producer NF may send the pending notification data to the event consumer NF before handling the exception.

The pending notification data may be any suitable notification data which is not sent to the event consumer NF. For example, there may be stored unsent event(s) in the event producer NF before a notification triggering condition is met. Some example scenarios may comprise the aggregation NWDAF, bulk data handling, analytics subscription transfer or DCCF relocation, etc.

In an embodiment, the pending notification data may comprise at least one stored unsent event.

The exception may be any suitable exception and the present disclosure has no limit on it. For example, the exception may cause the event producer NF to be unable to provide service to the event consumer NF. For example, the exception may be hardware exception, software exception, overload, maintenance, power saving, etc.

In an embodiment, the exception may comprise at least one of the event producer NF cannot handle analytics, the event producer NF cannot handle event data, the event producer NF receives an unsubscription request, the event producer NF decides to send a termination request, event data cannot be collected, subscription is transferred, DCCF cannot handle the analytics data or collected data, or aggregator NWDAF cannot handle the analytics.

FIG. 3b shows a flowchart of a method according to another embodiment of the present disclosure, which may be performed by an apparatus implemented in or at or as a first NF or communicatively coupled to the first NF. As such, the apparatus may provide means or modules for accomplishing various parts of the method 310 as well as means or modules for accomplishing other processes in conjunction with other components. For some parts which have been described in the above embodiments, the description thereof is omitted here for brevity.

At block 312, the first NF may send a second subscribe request to a third NF. The second subscribe request may comprise the first information.

The third NF may be any suitable network device or node or entity or function. For example, the third NF may be any of NFs as defined in various 3GPP specifications such as 3GPP TS 23.501 V18.0.0, 3GPP TS 23.503 V18.0.0 and 3GPP TS 23.288 V18.0.0.

In an embodiment, the third NF may comprise at least one of an ADRF, an aggregator NWDAF, a DCCF, an NWDAF, an NEF, an AMF, a SMF, a UDM, a GMLC, a NSACF, an AF, a SCP, a PCF, or a UPF.

In an embodiment, the third NF may be event producer (e.g.: NWDAF as the analtyics event producer, data source as the data event producer).

In a scenario, the first NF is the event consumer (e.g.: analytics consumer or data consumer), the second NF is DCCF (coordicate and bulk handling of analytics data and/or collected data) or aggregator NWDAF (aggregate analytics data), the third NF is the event producer (e.g.: NWDAF as the analystics producer or data source NF as the data collection producer).

The second subscribe request may be any suitable subscribe request such as exiting subscribe request or new subscribe request. In an embodiment, the second subscribe request may be any suitable subscribe request as defined in various 3GPP specifications such as 3GPP TS 23.502 V18.0.0, 3GPP TS 23.503 V18.0.0 and 3GPP TS 23.288 V18.0.0.

In an embodiment, the second subscribe request may comprise at least one of a data management subscribe request such as Ndccf_DataManagement_Subscribe request, an analytics subscribe request such as Nnwdaf_AnalyticsSubscription_Subscribe request, or an event exposure subscribe request.

For example, the second subscribe request may comprise at least one of
Nnwdaf_AnalyticsSubscription_Subscribe request,
Namf_EventExposure_Subscribe request,
Nadrf_DataManagement_RetrievalSubscribe request,
Npcf_PolicyAuthorization_Subscribe request,
Nudm_SDM_Subscribe request,
Ndccf_DataManagement_Subscribe request,
Naf_EventExposure_Subscribe request,
Nsmf_EventExposure_Subscribe request,
Nnwdaf_MLModelProvision_Subscribe request,
Nnsacf_SliceEventExposure_Subscribe request,
Nnef_EventExposure_Subscribe request,
Nnef_AnalyticsExposure_Subscribe request,
Nnwdaf_DataManagement_Subscribe request,
Nmfaf_3caDataManagement subscribe request,
Nadrf_DataManagement_StorageSubscriptionRequest,
Namf_Communication_NIN2MessageSubscribe request,
Namf_Communication_N2InfoSubscribe request,
Namf_Communication_AMFStatusChangeSubscribe request,
Namf_Communication_NonUeN2InfoSubscribe request,
Nudm_EventExposure_Subscribe request,
Npcf_EventExposure_Subscribe request,
Npcf_AMPolicyAuthorization_Subscribe request,
Nnef_AMPolicyAuthorization_Subscribe request,
Nnef_TimeSynchronization_CapsSubscribe request,
Nudr_DM_Subscribe request,
Nbsf_Management_Subscribe request,
Nudsf_UnstructuredDataManagement_Subscribe request,
Nnssf_NSSAIAvailability_Subscribe request,
Nucmf_UECapabilityManagement_Subscribe request,
Nupf_EventExposure_Subscribe request,
Ntsctsf_TimeSynchronization_CapsSubscribe request, or
Ntsctsf_QoSandTSCAssistance_Subscribe request, etc. as defined in 3GPP TS 23.502 V18.0.0 and 3GPP TS 23.288 V18.0.0.

The second subscribe request may comprise any suitable information. For example, the second subscribe request may comprise Event Reporting Information of Table 4.15.1-1.

FIG. 3c shows a flowchart of a method according to another embodiment of the present disclosure, which may be performed by an apparatus implemented in or at or as a first NF or communicatively coupled to the first NF. As such, the apparatus may provide means or modules for accomplishing various parts of the method 320 as well as means or modules for accomplishing other processes in conjunction with other components. For some parts which have been described in the above embodiments, the description thereof is omitted here for brevity.

At block 322, when an occurrence of the exception of the event producer NF, the first NF may receive a first message comprising the pending notification data from the third NF.

For example, the third NF may be the event producer NF. It may determine an occurrence of the exception and send the first message comprising the pending notification data to the first NF. As another example, the third NF may receive the pending notification data from another NF such as the event producer NF and then send the first message comprising the pending notification data to the first NF.

At block 324, the first NF may send a second message comprising the pending notification data to the second NF.

The first message and/or the second message may further comprise any other suitable information. In an embodiment, the first message and/or the second message may further comprise second information indicating a cause of notification of the pending notification data.

The second information may be of any suitable form such as a bit, a flag, an indicator, etc. In an embodiment, the second information may comprise a pending notification cause. Note that any other suitable name may be possible.

For example, the second information such as pending notification cause may indicate the cause of the pending notification of the stored unsent event(s), e.g., the data cannot be collected any more, the unsubscription request is received from the event consumer NF or the event producer NF decides to send a termination request etc.

In an embodiment, the cause of notification of the pending notification data may comprise at least one of an exception occurs in the event producer NF, the event producer NF cannot handle analytics, the event producer NF cannot handle event data, the event producer NF receives an unsubscription request, the event producer NF decides to send a termination request, event data cannot be collected, subscription is transferred, DCCF cannot handle the analytics data or collected data, or aggregator NWDAF cannot handle the analytics.

The first message and/or the second message may be any suitable message such as exiting message or new message. In an embodiment, the first message and/or the second message may comprise at least one of a notification message or an unsubscription response.

For example, when the event producer NF receives an unsubscription request, it may send an unsubscription response. In this case the first message and/or the second message may be the unsubscription response.

The notification message may be any suitable notification message such as exiting message or a new message. In an embodiment, the notification message may be a notification message corresponding to the first subscribe request and/or the second subscribe request.

In an embodiment, the notification message may comprise at least one of a data management notification message, an analytics subscription notification message, or an event exposure notification message.

In an embodiment, the notification message may comprise a termination request.

For example, when the event producer NF such as NWDAF requests to terminate the (analytics) subscription, i.e. the event producer NF such as NWDAF will not provide further notifications related to this subscription, with cause value (e.g. user consent revoked, event producer NF overload, UE moved out of event producer NF's serving area, etc.), the event producer NF such as NWDAF may send a notification message comprising the termination request.

FIG. 3d shows a flowchart of a method according to another embodiment of the present disclosure, which may be performed by an apparatus implemented in or at or as a first NF or communicatively coupled to the first NF. As such, the apparatus may provide means or modules for accomplishing various parts of the method 330 as well as means or modules for accomplishing other processes in conjunction with other components. For some parts which have been described in the above embodiments, the description thereof is omitted here for brevity.

At block 332, the first NF may determine an occurrence of the exception.

At block 334, the first NF may send a third message comprising the pending notification data to the second NF or the event consumer NF based on the first information.

For example, the first NF may be the event producer NF. It may determine an occurrence of the exception and send the third message comprising the pending notification data to the second NF or the event consumer NF.

The third message may further comprise any other suitable information. In an embodiment, the third message may further comprise third information indicating a cause of notification of the pending notification data.

The third information may be of any suitable form such as a bit, a flag, an indicator, etc. In an embodiment, the third information may comprise a pending notification cause. Note that any other suitable name may be possible.

For example, the third information such as pending notification cause may indicate the cause of the pending notification of the stored unsent event(s), e.g., the data cannot be collected any more, the unsubscription request is received from the event consumer NF or the event producer NF decides to send a termination request etc.

In an embodiment, the cause of notification of the pending notification data may comprise at least one of an exception occurs in the event producer NF, the event producer NF cannot handle analytics, the event producer NF cannot handle event data, the event producer NF receives an unsubscription request, the event producer NF decides to send a termination request, event data cannot be collected, subscription is transferred, DCCF cannot handle the analytics data or collected data, or aggregator NWDAF cannot handle the analytics.

The third message may be any suitable message such as exiting message or new message. In an embodiment, the third message comprises at least one of a notification message or an unsubscription response.

For example, when the first NF receives an unsubscription request, it may send an unsubscription response. In this case the third message may be the unsubscription response.

The notification message may be any suitable notification message such as exiting message or a new message. In an embodiment, the notification message may be a notification message corresponding to the first subscribe request.

In an embodiment, the notification message may comprise at least one of a data management notification message, an analytics subscription notification message, or an event exposure notification message.

In an embodiment, the notification message may comprise a termination request.

For example, when the event producer NF such as NWDAF requests to terminate the (analytics) subscription, i.e. the event producer NF such as NWDAF will not provide further notifications related to this subscription, with cause value (e.g. user consent revoked, event producer NF overload, UE moved out of event producer NF's serving area, etc.), the event producer NF such as NWDAF may send a notification message comprising the termination request.

FIG. 3e shows a flowchart of a method according to another embodiment of the present disclosure, which may be performed by an apparatus implemented in or at or as a first NF or communicatively coupled to the first NF. As such, the apparatus may provide means or modules for accomplishing various parts of the method 340 as well as means or modules for accomplishing other processes in conjunction with other components. For some parts which have been described in the above embodiments, the description thereof is omitted here for brevity.

At block 342, the first NF may receive a first notification message or a first unsubscription response comprising pending notification data from a third NF.

In an embodiment, the first notification message may further comprise second information indicating a cause of notification of the pending notification data.

In an embodiment, the first notification message may further comprise information notifying a consumer instance when data or analytics is to be deleted.

FIG. 3f shows a flowchart of a method according to another embodiment of the present disclosure, which may be performed by an apparatus implemented in or at or as a first NF or communicatively coupled to the first NF. As such, the apparatus may provide means or modules for accomplishing various parts of the method 350 as well as means or modules for accomplishing other processes in conjunction with other components. For some parts which have been described in the above embodiments, the description thereof is omitted here for brevity.

At block 352, the first NF may send, to the third NF, a first notification response message comprising information indicating if the consumer instance will retrieve stored data or analytics prior to deletion.

FIG. 3g shows a flowchart of a method according to another embodiment of the present disclosure, which may be performed by an apparatus implemented in or at or as a first NF or communicatively coupled to the first NF. As such, the apparatus may provide means or modules for accomplishing various parts of the method 360 as well as means or modules for accomplishing other processes in conjunction with other components. For some parts which have been described in the above embodiments, the description thereof is omitted here for brevity.

At block 362, the first NF may send a second notification message or a second unsubscription response comprising the pending notification data to a second NF.

In an embodiment, the second notification message may further comprise the second information indicating the cause of notification of the pending notification data.

In an embodiment, the second notification message further comprises information notifying a consumer instance when data or analytics is to be deleted.

FIG. 3h shows a flowchart of a method according to another embodiment of the present disclosure, which may be performed by an apparatus implemented in or at or as a first NF or communicatively coupled to the first NF. As such, the apparatus may provide means or modules for accomplishing various parts of the method 370 as well as means or modules for accomplishing other processes in conjunction with other components. For some parts which have been described in the above embodiments, the description thereof is omitted here for brevity.

At block 372, the first NF may receive, from the second NF, a second notification response message comprising information indicating if the consumer instance will retrieve stored data or analytics prior to deletion.

In an embodiment, the first NF and/or the second NF may comprise at least one of an analytics data repository function (ADRF), an aggregator NWDAF, a data collection coordination (DCCF), a network data analytics function (NWDAF), a network exposure function (NEF), an access and mobility management function (AMF), a session management function (SMF), a unified data management (UDM), a network slice admission control function (NSACF), an application function (AF), a policy control function (PCF), or a user plane function (UPF).

In an embodiment, the cause of notification of the pending notification data may comprise at least one of an exception occurs in the event producer NF, the event producer NF cannot handle analytics, the event producer NF cannot handle event data, the event producer NF receives an unsubscription request, the event producer NF decides to send a termination request, event data cannot be collected, subscription is transferred, DCCF cannot handle the analytics data or collected data, or aggregator NWDAF cannot handle the analytics.

In an embodiment, the notification message may comprise at least one of a data management notification message, an analytics subscription notification message, or an event exposure notification message.

In an embodiment, the notification message may comprise a termination request.

In an embodiment, the third NF may comprise at least one of an analytics data repository function (ADRF), an aggregator NWDAF, a data collection coordination (DCCF), a network data analytics function (NWDAF), a network exposure function (NEF), an access and mobility management function (AMF), a session management function (SMF), a unified data management (UDM), a network slice admission control function (NSACF), an application function (AF), a policy control function (PCF), or a user plane function (UPF).

FIG. 4a shows a flowchart of a method according to another embodiment of the present disclosure, which may be performed by an apparatus implemented in or at or as a second NF or communicatively coupled to the second NF. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the second NF may send a first subscribe request to a first NF. The first subscribe request may comprise first information indicating whether an event producer NF is required to send pending notification data to an event consumer NF before handling an exception.

In an embodiment, the first subscribe request may comprise at least one of a data management subscribe request, an analytics subscribe request, or an event exposure subscribe request.

In an embodiment, the first information may comprise a pending notification flag.

In an embodiment, when the pending notification flag is set as true, it indicates that the event producer NF is required to send the pending notification data to the event consumer NF before handling the exception.

In an embodiment, when the pending notification flag is set as false or not present, it indicates that the event producer NF is not required to send the pending notification data to the event consumer NF before handling the exception.

In an embodiment, the exception may comprise at least one of the event producer NF cannot handle analytics, the event producer NF cannot handle event data, the event producer NF receives an unsubscription request, the event producer NF decides to send a termination request, event data cannot be collected, subscription is transferred, DCCF cannot handle the analytics data or collected data, or aggregator NWDAF cannot handle the analytics.

In an embodiment, the pending notification data may comprise at least one stored unsent event.

In an embodiment, the first NF may comprise at least one of an ADRF, an aggregator NWDAF, a DCCF, an NWDAF, an NEF, an AMF, a SMF, a UDM, a GMLC, a NSACF, an AF, a SCP, a PCF, or a UPF.

In an embodiment, the second NF may comprise at least one of an ADRF, an aggregator NWDAF, a DCCF, an NWDAF, an NEF, an AMF, a SMF, a UDM, a GMLC, a NSACF, an AF, a SCP, a PCF, or a UPF.

In an embodiment, the event producer NF may comprise at least one of an ADRF, an aggregator NWDAF, a DCCF, an NWDAF, an NEF, an AMF, a SMF, a UDM, a GMLC, a NSACF, an AF, a SCP, a PCF, or a UPF.

In an embodiment, the event consumer NF may comprise at least one of an ADRF, an aggregator NWDAF, a DCCF, an NWDAF, an NEF, an AMF, a SMF, a UDM, a GMLC, a NSACF, an AF, a SCP, a PCF, or a UPF.

FIG. 4b shows a flowchart of a method according to another embodiment of the present disclosure, which may be performed by an apparatus implemented in or at or as a second NF or communicatively coupled to the second NF. As such, the apparatus may provide means or modules for accomplishing various parts of the method 410 as well as means or modules for accomplishing other processes in conjunction with other components. For some parts which have been described in the above embodiments, the description thereof is omitted here for brevity.

At block 412, when an occurrence of the exception of the event producer NF, the second NF may receive a message comprising the pending notification data from the first NF or the event producer NF.

For example, the first NF may be the event producer NF. It may determine an occurrence of the exception and send a message comprising the pending notification data to the second NF. As another example, the first NF may receive the pending notification data from another NF such as the event producer NF and then send the first message comprising the pending notification data to the second NF.

In an embodiment, the message may further comprise fourth information indicating a cause of notification of the pending notification data.

The fourth information may be of any suitable form such as a bit, a flag, an indicator, etc. In an embodiment, the fourth information may comprise a pending notification cause. Note that any other suitable name may be possible.

In an embodiment, the cause of notification of the pending notification data may comprise at least one of an exception occurs in the event producer NF, the event producer NF cannot handle analytics, the event producer NF cannot handle event data, the event producer NF receives an unsubscription request, the event producer NF decides to send a termination request, event data cannot be collected, subscription is transferred, DCCF cannot handle the analytics data or collected data, or aggregator NWDAF cannot handle the analytics.

The message may be any suitable message such as existing message or new message. In an embodiment, the message may comprise at least one of a notification message, or an unsubscription response.

In an embodiment, the notification message may comprise at least one of a data management notification message, an analytics subscription notification message, or an event exposure notification message.

In an embodiment, the notification message comprises a termination request.

FIG. 4c shows a flowchart of a method according to another embodiment of the present disclosure, which may be performed by an apparatus implemented in or at or as a third NF or communicatively coupled to the third NF. As such, the apparatus may provide means or modules for accomplishing various parts of the method 420 as well as means or modules for accomplishing other processes in conjunction with other components. For some parts which have been described in the above embodiments, the description thereof is omitted here for brevity.

At block 422, the third NF may send a first notification message or a first unsubscription response comprising pending notification data to a first NF.

In an embodiment, the first notification message may further comprise second information indicating a cause of notification of the pending notification data.

In an embodiment, the first notification message may further comprise information notifying a consumer instance when data or analytics is to be deleted.

FIG. 4d shows a flowchart of a method according to another embodiment of the present disclosure, which may be performed by an apparatus implemented in or at or as a third NF or communicatively coupled to the third NF. As such, the apparatus may provide means or modules for accomplishing various parts of the method 430 as well as means or modules for accomplishing other processes in conjunction with other components. For some parts which have been described in the above embodiments, the description thereof is omitted here for brevity.

At block 432, the third NF may receive, from the first NF, a first notification response message comprising information indicating if the consumer instance will retrieve stored data or analytics prior to deletion.

In an embodiment, the first NF may comprise at least one of an analytics data repository function (ADRF), an aggregator NWDAF, a data collection coordination (DCCF), a network data analytics function (NWDAF), a network exposure function (NEF), an access and mobility management function (AMF), a session management function (SMF), a unified data management (UDM), a network slice admission control function (NSACF), an application function (AF), a policy control function (PCF), or a user plane function (UPF).

In an embodiment, the cause of notification of the pending notification data may comprise at least one of an exception occurs in the event producer NF, the event producer NF cannot handle analytics, the event producer NF cannot handle event data, the event producer NF receives an unsubscription request, the event producer NF decides to send a termination request, event data cannot be collected, subscription is transferred, DCCF cannot handle the analytics data or collected data, or aggregator NWDAF cannot handle the analytics.

In an embodiment, the notification message may comprise at least one of a data management notification message, an analytics subscription notification message, or an event exposure notification message.

In an embodiment, the notification message may comprise a termination request.

In an embodiment, the third NF may comprise at least one of an analytics data repository function (ADRF), an aggregator NWDAF, a data collection coordination (DCCF), a network data analytics function (NWDAF), a network exposure function (NEF), an access and mobility management function (AMF), a session management function (SMF), a unified data management (UDM), a network slice admission control function (NSACF), an application function (AF), a policy control function (PCF), or a user plane function (UPF).

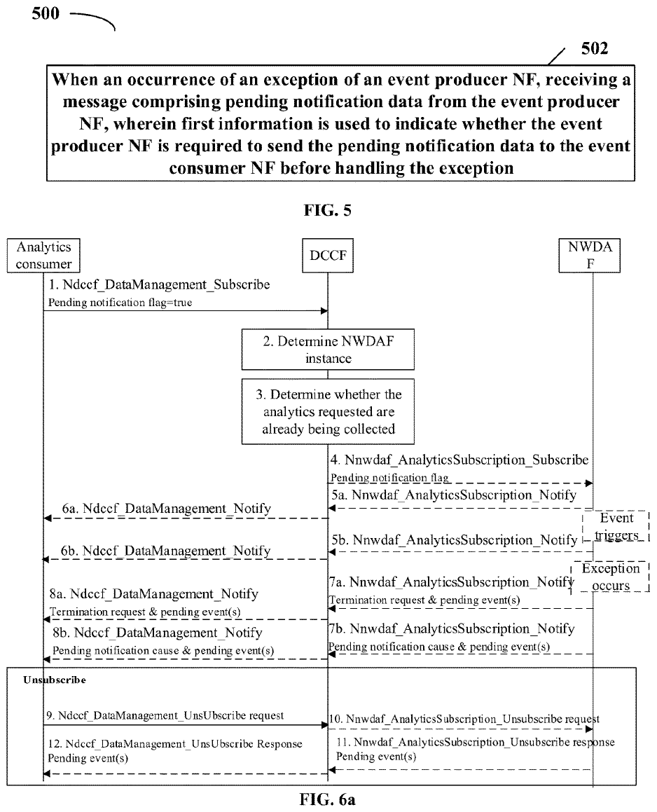

FIG. 5 shows a flowchart of a method according to another embodiment of the present disclosure, which may be performed by an apparatus implemented in or at or as an event consumer NF or communicatively coupled to the event consumer NF. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, when an occurrence of an exception of an event producer NF, the event consumer NF may receive a message comprising pending notification data from the event producer NF.

In an embodiment, first information may be used to indicate whether the event producer NF is required to send the pending notification data to the event consumer NF before handling the exception. The first information may be received by the event producer NF according to above embodiments. Alternatively, the first information may be preconfigured in the event producer NF.

In an embodiment, the first information may comprise a pending notification flag.

In an embodiment, when the pending notification flag is set as true, it may indicate that the event producer NF is required to send the pending notification data to the event consumer NF before handling the exception.

In an embodiment, when the pending notification flag is set as false or not present, it may indicate that the event producer NF is not required to send the pending notification data to the event consumer NF before handling the exception.

In an embodiment, the exception may comprise at least one of the event producer NF cannot handle analytics, the event producer NF cannot handle event data, the event producer NF receives an unsubscription request, the event producer NF decides to send a termination request, event data cannot be collected, subscription is transferred, DCCF cannot handle the analytics data or collected data, or aggregator NWDAF cannot handle the analytics.

In an embodiment, the pending notification data may comprise at least one stored unsent event.

In an embodiment, the message further may comprise fifth information indicating a cause of notification of the pending notification data.

The fifth information may be of any suitable form such as a bit, a flag, an indicator, etc. In an embodiment, the fifth information may comprise a pending notification cause. Note that any other suitable name may be possible.

In an embodiment, the cause of notification of the pending notification data may comprise at least one of an exception occurs in the event producer NF, the event producer NF cannot handle analytics, the event producer NF cannot handle event data, the event producer NF receives an unsubscription request, the event producer NF decides to send a termination request, event data cannot be collected, subscription is transferred, DCCF cannot handle the analytics data or collected data, or aggregator NWDAF cannot handle the analytics.

The message may be any suitable message such as existing message or new message. In an embodiment, the message may comprise at least one of a notification message or an unsubscription response.

In an embodiment, the notification message may comprise at least one of a data management notification message, an analytics subscription notification message, or an event exposure notification message.

In an embodiment, the notification message may comprise a termination request.

In an embodiment, the event producer NF may comprise at least one of an ADRF, an aggregator NWDAF, a DCCF, an NWDAF, an NEF, an AMF, a SMF, a UDM, a GMLC, a NSACF, an AF, a SCP, a PCF, or a UPF.

In an embodiment, the event consumer NF may comprise at least one of an ADRF, an aggregator NWDAF, a DCCF, an NWDAF, an NEF, an AMF, a SMF, a UDM, a GMLC, a NSACF, an AF, a SCP, a PCF, or a UPF.

In an embodiment, it may add the pending notification flag in the event report information which may indicate the event consumer NF required pending notification action before the event producer NF handles an exception. The event reporting information may be included in Nnwdaf_AnalyticsSubscription_Subscribe, Nnwdaf_DataManagement_Subscribe and Ndccf_DataManagement_Subscribe service operations.

In an embodiment, flexible pending notification handle is proposed. The pending notification data can be included in the unsubscription response if the consumer NF takes the notification end point, can be sent together with the termination request, or as a separate notification message.

In an embodiment, it may add Pending Notification Cause in the Nnwdaf_AnalyticsSubscription_Notify, Nnwdaf_DataManagement_Notify and Ndccf_DataManagement_Notify service operations together with the pending event(s) reported.

In an embodiment, it may enable the event consumer NF to indicate the event producer NF action on how to handle the stored unsent event(s) upon an exception occurs.

In an embodiment, it may enable the event producer NF to effectively handle the pending notification before handling an exception.

In an embodiment, it may enable flexible pending notification messaging to minimize the handling impacts.

In an embodiment, in Table 4.15.1-1 of 3GPP TS 23.502 V18.0.0, it may add the optional Pending notification flag as a new Event Reporting Information Parameter, with description as “Indicates to the Event provider NF to send the pending notification to the Event consumer NF with the stored unsent event(s) before handling an exception e.g. the unsubscription request is received or the Event provider NF decides to send a termination request etc.”

For example, Table 4.15.1-1 of 3GPP TS 23.502 V18.0.0 may be amended as following.

TABLE 4.15.1-1
Event Reporting Information

| Event Reporting Information | | Presence |
|---|---|---|
| Parameter | Description | requirement |
| Event reporting mode | Mode of reporting - e.g. reporting up to a maximum number of | mandatory |
| | reports, periodic reporting along with periodicity, reporting up | |
| | to a maximum duration, reporting when threshold is reached | |
| Maximum number of reports | Maximum number of reports after which the event | (see NOTE 1) |
| | subscription ceases to exist | |
| Maximum duration of reporting | Maximum duration after which the event subscription ceases | (see NOTE 1) |
| | to exist | |
| Immediate reporting flag | The Event provider NF notifies the current status of the | |
| | subscribed event, if available, immediately to the consumer | |
| | NF. | |
| Sampling ratio | Percentage of sampling (1% . . . 100%) among impacted UEs. | Optional |
| | | (see NOTE 2) |
| Partitioning criteria | Criteria for partitioning UEs before applying sampling ratio. | Optional |
| | | (see NOTE 2) |
| Group Reporting Guard Time | Parameter for group-based monitoring configuration to | Optional |
| | indicate the time for which the Monitoring Event Reporting(s) | |
| | related with the UEs in a group can be aggregated before | |
| | sending them to the consumer NF. | |
| Deactivate notification flag | Indicates to the Event provider NF that the notification of the | Optional |
| | available events shall be muted until the Event consumer NF | |
| | provides the retrieval notification flag to retrieve the events | |
| | stored. | |
| Retrieval notification flag | Indicates to the Event provider NF to send the notification to | optional |
| | the Event consumer NF with the stored events and mutes again | |
| | the notification of future events. | |
| Pending notification flag | Indicates to the Event provider NF to send the pending | Optional |
| | notification to the Event consumer NF with the stored unsent | |
| | event(s) before handling an exception e.g.: DCCF cannot | |
| | handle the analytics data or collected data, or aggregator | |
| | NWDAF cannot handle the analytics, the unsubscription | |
| | request is received, the Event provider NF decides to send a | |
| | termination request, the event subscription is transferred, or | |
| | the bulk or aggregation handling of event data cannot be | |
| | processed any now etc. | |
| Granularity of dynamics | The maximum amount of dynamics in the event which allows | optional |
| | to skip an event notification. | (see NOTE 3) |
| Reporting type | Event provider NF reports only when the events differs from | optional |
| | the previously notified event. | (see NOTE 4) |
| Reporting Threshold | Threshold values indicate conditions on the level to be reached | Optional |
| | for the reporting | (see NOTE 5) |

(NOTE 1):
The requester shall include 2) Maximum number of reports or 3) Maximum duration of reporting, or both, depending on 1) Event reporting mode.
(NOTE 2):
Parameter only applicable to certain event IDs reporting metrics (e.g. Number of UEs present in a geographical area) used and used e.g. by the NWDAF for data collection.
(NOTE 3):
The Granularity of dynamics includes 1) the range of scalar value, 2) the list of events identification, or 3) the previous notification. The range of scalar value is only applicable to the event depicted as number (e.g. the number of UE), the others is applicable to the event depicted as identification (e.g. UE location, UE identification).
(NOTE 4):
The differences in event include the events have been newly appeared, disappeared and changed from the previous notification.
(NOTE 5):
This parameter is included only if the Event reporting mode indicates reporting when threshold is reached.

In an embodiment, it may add the usage description as below in clause 4.15.1 of 3GPP TS 23.502 V18.0.0.

Pending notification flag enable to require the event producer NF to send the pending notification of stored unsent event(s) before handling an exception (e.g.: the unsubscription request is received or the event producer NF decides to send terminate request, the event subscription is transferred, or the bulk or aggregation handling of event data cannot be processed any now etc.).

When the pending notification flag=true, the event producer NF should send the pending notification of the stored unsent event(s) before handling an exception. The pending notification can be included in one of below:
in the same notification message if the event produce NF decides to send terminate request notification to the event consumer NF;
in the unsubscription response if the event consumer NF itself is the notification end point; or
in a separate notification message contains the pending notification cause before the exception handling.

When the pending notification flag=false or not present, the event producer NF needn't send the pending notification and may discard the stored unsent event(s) if cannot be handled upon the exception.

In an embodiment, clause 7.2.3 of 3GPP TS 23.288 V18.0.0 may be amended as following. In clause 7.2.3, it may add optional Pending Notification event(s).

7.2.3 Nnwdaf_AnalyticsSubscription_Unsubscribe service operation
Service operation name: Nnwdaf_AnalyticsSubscription_Unsubscribe.
Description: Unsubscribe to NWDAF analytics.
Inputs, Required: Subscription Correlation ID.
Inputs, Optional: None.
Outputs, Required: Operation execution result indication.
Outputs, Optional: Pending Notification data which may include the unsent event(s) data.

In an embodiment, in clause 7.2.4 of 3GPP TS 23.288 V18.0.0, Nnwdaf_AnalyticsSubscription_Notify service operation, below Pending Notification Cause and description may be added as input optional parameter:
Pending Notification Cause: indicates the cause of the pending notification of the stored unsent analytics event(s), e.g., an exception occurs in the aggregator NWDAF before T1, the unsubscription request is received from the analytics consumer NF or the NWDAF decides to send a termination request etc.

In an embodiment, in clause 7.4.3 of 3GPP TS 23.288 V18.0.0, it may add optional pending notification event(s).

7.4.3 Nnwdaf_DataManagement_Unsubscribe service operation

Service operation name: Nnwdaf_DataManagement_Unsubscribe.

Description: The NF consumer unsubscribes to the NWDAF for data.

### Inputs, Required: Subscription Correlation ID.

Outputs, Required: Operation execution result indication.

Outputs, Optional: Pending Notification data which may include the unsent event(s) data.

In an embodiment, in clause 7.4.4 of 3GPP TS 23.288 V18.0.0, Nnwdaf_DataManagement_Notify service operation, below Pending Notification Cause and description may be added as input optional parameter.

Pending Notification Cause indicates the cause of the pending notification of the stored unsent event(s), e.g., the data cannot be collected any more, the unsubscription request is received from the event consumer NF or the event producer NF decides to send a termination request etc.

In an embodiment, in clause 8.2.3 of 3GPP TS 23.288 V18.0.0, it may add optional pending notification event(s).

8.2.3 Ndccf_DataManagement_Unsubscribe service operation
Service operation name: Ndccf_DataManagement_Unsubscribe
Description: The consumer unsubscribes to DCCF for data or analytics.
Inputs, Required: Subscription Correlation ID.
Inputs, Optional: None.
Outputs, Required: Operation execution result indication.
Outputs, Optional: Pending Notification data which may include the unsent event(s) data.

In an embodiment, in clause 8.2.4 of 3GPP TS 23.288 V18.0.0, Ndccf_DataManagement_Notify service operation, below Pending Notification Cause and description may be added as input optional parameter.

Pending Notification Cause indicates the cause of the pending notification of the stored unsent event(s), e.g., the data cannot be collected any more, the unsubscription request is received from the event consumer NF or the DCCF decides to send a termination request etc.

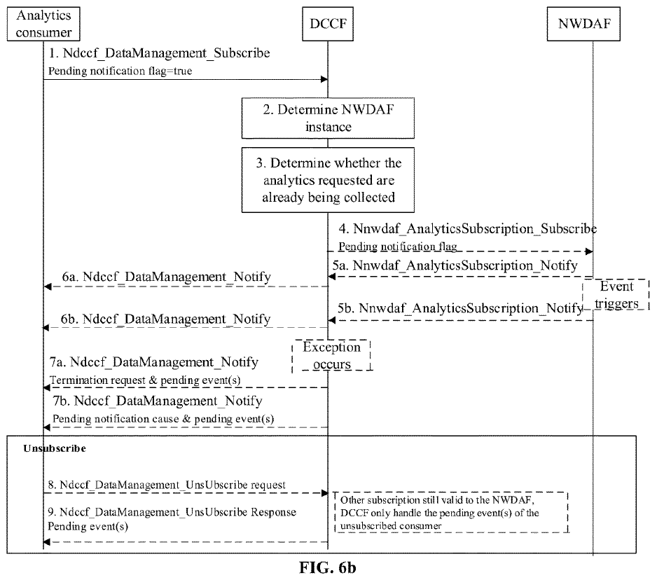

FIG. 6a shows a flowchart of a Subscribe-Notify method according to another embodiment of the present disclosure.

It may provide enhancement on pending analytics notification handling during Data management subscription/unsubscription/notify and analytics subscription/unsubscription/notify.

If Analytics consumer directly invoke NWDAF services without DCCF interaction, then similar procedure as in FIG. 6 between DCCF (as service consumer) and NWDAF (as service producer) applies.

Step 1. Analytics consumer may subscribe to analytics information via DCCF by invoking the Ndccf_DataManagement_Subscribe service operation. The pending notification flag is added. When it is set to true, it indicates the producer (i.e. DCCF) should/may report the pending unsent event(s) if an exception occurs.

Step 2. If the NWDAF instance or NWDAF Set is not identified by the analytics consumer, the DCCF may determine the NWDAF instances that can provide analytics.

Step 3. The DCCF may determine whether the analytics requested in step 1 are already being collected. If the requested analytics are already being collected by an Analytics Consumer, the DCCF may add the new analytics consumer to the list of analytics consumers that are subscribed for these analytics.

Step 4. The DCCF may invoke the Nnwdaf_AnalyticsSubscription_Subscribe service operation to the selected NWDAF. The pending notification flag may be added. When it is set to true, it may indicate the producer (i.e.: NWDAF) should/may report the pending unsent event(s) if an exception occurs.

Steps 5a and 5b. When new output analytics are available and the event reporting triggers occur, the NWDAF may notify the analytics information to the DCCF by invoking Nnwdaf_AnalyticsSubscription_Notify service operation.

Steps 6a and 6b. The DCCF may use Ndccf_DataManagement_Notify to send the analytics to all notification endpoints indicated in step 1.

Step 7a. If an exception occurs in the producer (i.e. NWDAF) and the NWDAF decides to send a termination request in a notification message, the pending notification event(s) may be added together in the same notification message. Pending notification event(s) is newly added.

Step 7b. If an exception occurs in the producer (i.e. NWDAF), the NWDAF may decide to send pending notification event(s) with pending notification cause in a separate notification message. Pending notification event(s) and pending notification cause are newly added.

Step 8a. The DCCF may deliver the termination exception notification message to the consumer, including the termination request and the pending notification event(s) together in the same notification message. Pending notification event(s) is newly added.

Step 8b. The DCCF may deliver the pending notification message to the consumer including the pending notification event(s) with pending notification cause. Pending notification event(s) and pending notification cause are newly added.

Step 9. When the Analytics Consumer no longer wants analytics to be collected, it may send Ndccf_DataManagement_Unsubscribe request message to the DCCF.

Step 10. If there are no other Analytics Consumers subscribed to the analytics, the DCCF may unsubscribe with the NWDAF.

Step 11. The NWDAF may include the pending unsent analytics event(s) in the Nnwdaf_AnalyticsSubscription_Unsubscribe response message to the DCCF. Pending notification event(s) is newly added.

Step 12. The DCCF may include the received pending unsent analytics event(s) in the Ndccf_DataManagement_Unsubscribe response message to the analytics consumer. Pending notification event(s) is newly added.

If other subscriptions are still valid or the notification end point is not the consumer itself, the pending notification event(s) to the specific analytics notification end point may be sent in a separation notification message as described in step 7b and 8b.

FIG. 6b shows a flowchart of a Subscribe-Notify method according to another embodiment of the present disclosure.

It may provide enhancement on pending analytics notification handling during Data management subscription/unsubscription/notify and analytics subscription/unsubscription/notify.

If Analytics consumer directly invoke NWDAF services without DCCF interaction, then similar procedure as in FIG. 6 between DCCF (as service consumer) and NWDAF (as service producer) applies.

Step 1. Analytics consumer may subscribe to analytics information via DCCF by invoking the Ndccf_DataManagement_Subscribe service operation. The pending notification flag is added. When it is set to true, it indicates the producer (i.e. DCCF) should/may report the pending unsent event(s) if an exception occurs.

Step 2. If the NWDAF instance or NWDAF Set is not identified by the analytics consumer, the DCCF may determine the NWDAF instances that can provide analytics.

Step 3. The DCCF may determine whether the analytics requested in step 1 are already being collected. If the requested analytics are already being collected by an Analytics Consumer, the DCCF may add the new analytics consumer to the list of analytics consumers that are subscribed for these analytics.

Step 4. The DCCF may invoke the Nnwdaf_AnalyticsSubscription_Subscribe service operation to the selected NWDAF. The pending notification flag may be added. When it is set to true, it may indicate the producer (i.e.: NWDAF) should/may report the pending unsent event(s) if an exception occurs.

Steps 5a and 5b. When new output analytics are available and the event reporting triggers occur, the NWDAF may notify the analytics information to the DCCF by invoking Nnwdaf_AnalyticsSubscription_Notify service operation.

Steps 6a and 6b. The DCCF may use Ndccf_DataManagement_Notify to send the analytics to all notification endpoints indicated in step 1.

Step 7a. If an exception occurs in the producer (i.e. DCCF) and the DCCF decides to send a termination request in a notification message, the pending notification event(s) may be added together in the same notification message. Pending notification event(s) is newly added.

Step 7b. If an exception occurs in the producer (i.e. DCCF), the DCCF may decide to send pending notification event(s) with pending notification cause in a separate notification message. Pending notification event(s) and pending notification cause are newly added.

Step 8. When the Analytics Consumer no longer wants analytics to be collected, it may send Ndccf_DataManagement_Unsubscribe request message to the DCCF.

Step 9. The DCCF may include the received pending unsent analytics event(s) in the Ndecf_DataManagement_Unsubscribe response message to the analytics consumer. Pending notification event(s) is newly added.

Other subscription still valid to the NWDAF, DCCF only handle the pending event(s) of the unsubscribed consumer.

FIG. 7a shows a flowchart of a Subscribe-Notify method according to another embodiment of the present disclosure.

It may provide enhancement on pending data collection notification handling during Data Management subscription/unsubscription/notify and Data collection subscription/unsubscription/notify.

If data consumer directly invoke data source NF (e.g. AMF, SMF, AF event exposure) services without DCCF interaction, then similar procedure as in below flow chart between DCCF (as service consumer) and data source NF (as service producer) applies.

Step 1. Data consumer may subscribe to data collection information via DCCF by invoking the Ndccf_DataManagement_Subscribe service operation. The pending notification flag is added. When it is set to true, it indicates the producer (i.e. DCCF) should report the pending unsent event(s) if exception occurs.

Step 2. The DCCF may check and handle the user consent with the UDM if not checked by the consumer.

Step 3. If the data source instance is not identified by the data consumer, the DCCF may determine the data source NF instances that can provide the required data information.

Step 4. The DCCF may determine whether the data requested in step 1 is already being collected. If the requested data is already being collected by an data consumer, the DCCF may add the new data consumer to the list of data consumers that are subscribed for the data.

Step 5. The DCCF may invoke the Nnf_EventExposure_Subscribe service operation to the selected data source NF. The pending notification flag may be added. When it is set to true, it may indicate the producer (e.g., AMF, SMF, AF etc.) should report the pending unsent event(s) if exception occurs.

Steps 6a-6b. When new data are available and the event reporting triggers occur, the data source NF may notify the collected data to the DCCF by invoking Nnf_EventExposure_Notify service operation.

Steps 7a-7b. The DCCF may use Ndccf_DataManagement_Notify to send the collected data to all notification endpoints indicated in step 1.

Step 8a. If an exception occurs in the producer (e.g. AMF, SMF, AF, etc.) and the producer decides to send a termination request in a notification message, the pending notification event(s) may be added together in the same notification message. Pending notification event(s) is newly added.

Step 8b. If an exception occurs in the producer (e.g. AMF, SMF, AF, etc.), the producer may decide to send pending notification event(s) with pending notification cause in a separate notification message. Pending notification event(s) and pending notification cause are newly added.

Step 9a. The DCCF may deliver the termination exception notification message to the consumer, including the termination request and the pending notification event(s) together in the same notification message. Pending notification event(s) is newly added.

Step 9b. The DCCF may deliver the pending notification message to the consumer including the pending notification event(s) with pending notification cause. Pending notification event(s) and pending notification cause are newly added.

Step 10. When the data consumer no longer wants data to be collected, it may send Ndccf_DataManagement_Unsubscribe request message to the DCCF

Step 11. If there are no other data consumers subscribed to the collected data, the DCCF may unsubscribe with the data source.

Step 12. The data source NF may include the pending unsent notification event (collected data) in the Nnf_EventExposure_Unsubscribe response message to the DCCF. Pending notification event (e.g., collected data) is newly added.

Step 13. The DCCF may include the received pending unsent unsent event(s) (e.g., collected data) in the Ndccf_DataManagement_Unsubscribe response message to the data consumer. Pending notification event(s) is newly added.

If other subscriptions are still valid or the notification end point is not the consumer itself, the pending notification event(s) to the specific data notification end point may be sent in a separation notification message as described in step 8b and 9b.

FIG. 7b shows a flowchart of a Subscribe-Notify method according to another embodiment of the present disclosure.

It may provide enhancement on pending data collection notification handling during Data Management subscription/unsubscription/notify and Data collection subscription/unsubscription/notify.

If data consumer directly invoke data source NF (e.g. AMF, SMF, AF event exposure) services without DCCF interaction, then similar procedure as in below flow chart between DCCF (as service consumer) and data source NF (as service producer) applies.

Step 1. Data consumer may subscribe to Data collection information via DCCF by invoking the Ndccf_DataManagement_Subscribe service operation. The pending notification flag is added. When it is set to true, it indicates the producer (i.e. DCCF) should report the pending unsent event(s) if exception occurs.

Step 2. The DCCF may check and handle the user consent with the UDM if not checked by the consumer.

Step 3. If the data source instance is not identified by the data consumer, the DCCF may determine the data source NF instances that can provide the required data information.

Step 4. The DCCF may determine whether the data requested in step 1 is already being collected. If the requested data is already being collected by an data consumer, the DCCF may add the new data consumer to the list of data consumers that are subscribed for the data.

Step 5. The DCCF may invoke the Nnf_EventExposure_Subscribe service operation to the selected data source NF. The pending notification flag may be added. When it is set to true, it may indicate the producer (e.g.: AMF, SMF, AF etc.) should report the pending unsent event(s) if exception occurs.

Steps 6a-6b. When new data are available and the event reporting triggers occur, the data source NF may notify the collected data to the DCCF by invoking Nnf_EventExposure_Notify service operation.

Steps 7a-7b. The DCCF may use Ndccf_DataManagement_Notify to send the collected data to all notification endpoints indicated in step 1.

Step 8a. If an exception occurs in the producer (i.e. DCCF) and the DCCF decides to send a termination request in a notification message, the pending notification event(s) may be added together in the same notification message. Pending notification event(s) is newly added.

Step 8b. If an exception occurs in the producer (i.e. DCCF), the DCCF may decide to send pending notification event(s) with pending notification cause in a separate notification message. Pending notification event(s) and pending notification cause are newly added.

Step 9. When the data consumer no longer wants data to be collected, it may send Ndccf_DataManagement_Unsubscribe request message to the DCCF.

Step 10. The DCCF may include the received pending unsent event(s) in the Ndccf_DataManagement_Unsubscribe response message to the data consumer. Pending notification event(s) is newly added.

Other subscription still valid to the data source, DCCF only handle the pending event(s) of the unsubscribed consumer.

Embodiments herein may provide many advantages, of which a non-exhaustive list of examples follows. In some embodiments herein, the pending notification data (such as collection event) can avoid losing notifications from NF (such as NWDAF/DCCF) upon some exception occurs. In some embodiments herein, it supports enhancement (e.g. NWDAF) on related more complete and much accurate analytics handling. In some embodiments herein, the pending notification data (such as analytics event) can enhance the analytics consumer on related more complete and much accurate analytics output based actions. In some embodiments herein, the added “pending notification flag” in the Event Reporting Information table and the usage description in clause 4.15.1 of TS 23.502 V18.0.0 can also be commonly utilized by other NF event(s) exposure case with stored unsent event(s) upon an exception occurs to complete and enhance the exceptional event(s) reporting and aligned handling with the exception cases. In some embodiments herein, flexible pending notification handle is proposed. In some embodiments herein, it may enable the event consumer NF to indicate the event producer NF action on how to handle the stored unsent event(s) upon an exception occurs. In some embodiments herein, it may enable the event producer NF to effectively handle the pending notification before handling an exception. In some embodiments herein, it may enable flexible pending notification messaging to minimize the handling impacts. The embodiments herein are not limited to the features and advantages mentioned above. A person skilled in the art will recognize additional features and advantages upon reading the following detailed description.

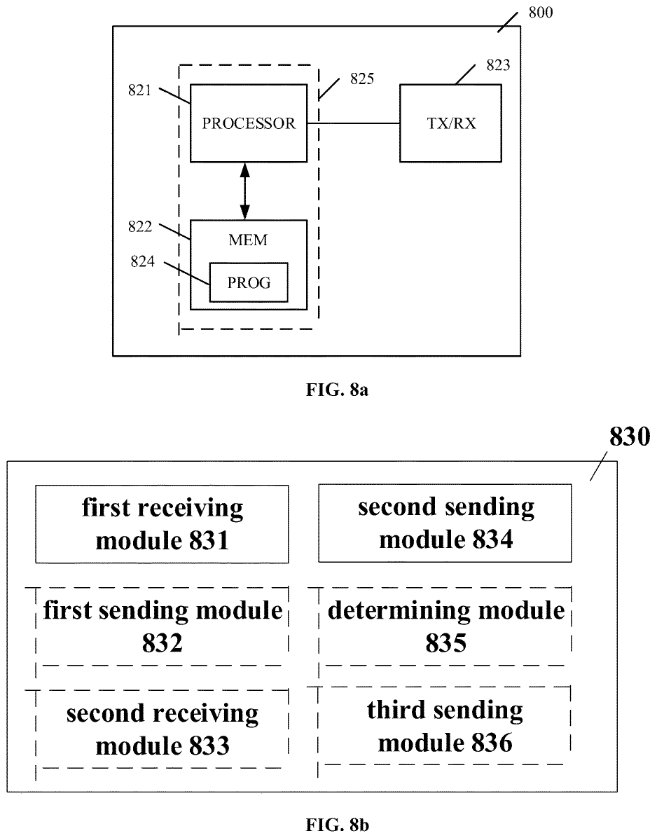

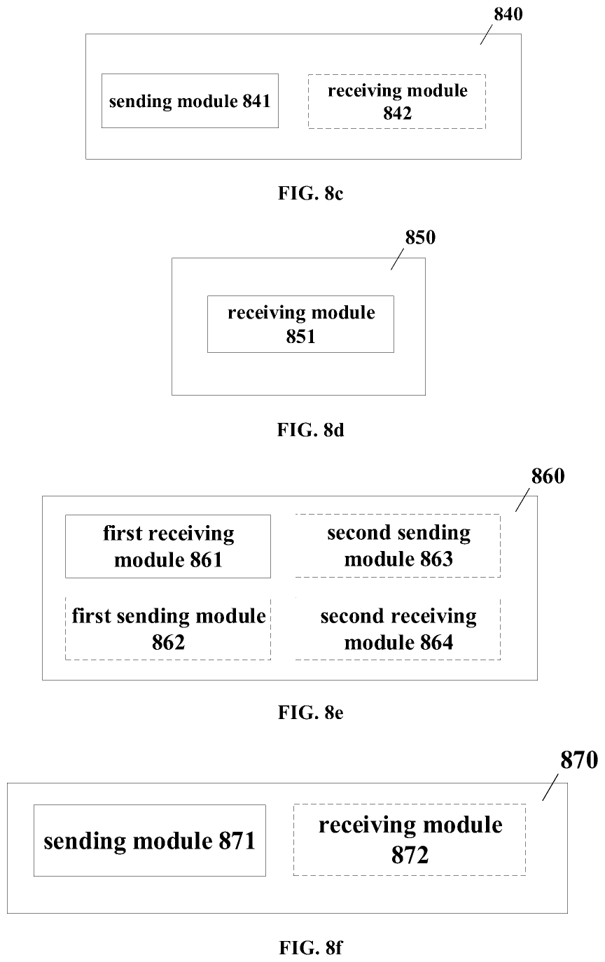

FIG. 8a is a block diagram showing an apparatus suitable for practicing some embodiments of the disclosure. For example, the first NF, the second NF, the third NF or the event consumer NF described above may be implemented as or through the apparatus 800.

The apparatus 800 comprises at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first NF, the memory 822 contains instructions executable by the processor 821, whereby the first NF operates according to any of the methods related to the first NF as described above.

In an embodiment where the apparatus is implemented as or at the second NF, the memory 822 contains instructions executable by the processor 821, whereby the second NF operates according to any of the methods related to the second NF as described above.

In an embodiment where the apparatus is implemented as or at the event consumer NF, the memory 822 contains instructions executable by the processor 821, whereby the event consumer NF operates according to any of the methods related to the event consumer NF as described above.

In an embodiment where the apparatus is implemented as or at the third NF, the memory 822 contains instructions executable by the processor 821, whereby the third NF operates according to any of the methods related to the third NF as described above.

FIG. 8b is a block diagram showing a first NF according to an embodiment of the disclosure. As shown, the first NF 830 comprises a first receiving module 831 configured to receive a first subscribe request from a second NF. The first subscribe request may comprise first information indicating whether an event producer NF is required to send pending notification data to an event consumer NF before handling an exception.

In an embodiment, the first NF 830 may further comprise a first sending module 832 configured to send a second subscribe request to a third NF. The second subscribe request comprises the first information.

In an embodiment, the first NF 830 may further comprise a second receiving module 833 configured to, when an occurrence of the exception of the event producer NF, receive a first message comprising the pending notification data from the third NF.

In an embodiment, the first NF 830 may further comprise a second sending module 834 configured to send a second message comprising the pending notification data to the second NF.

In an embodiment, the first NF 830 may further comprise a determining module 835 configured to determine an occurrence of the exception.

In an embodiment, the first NF 830 may further comprise a third sending module 836 configured to send a third message comprising the pending notification data to the second NF or the event consumer NF based on the first information.

FIG. 8c is a block diagram showing a second NF according to an embodiment of the disclosure. As shown, the second NF 840 comprises a sending module 841 configured to send a first subscribe request to a first NF. The first subscribe request may comprise first information indicating whether an event producer NF is required to send pending notification data to an event consumer NF before handling an exception.

In an embodiment, the second NF 840 may further comprise a receiving module 842 configured to, when an occurrence of the exception of the event producer NF, receive a message comprising the pending notification data from the first NF or the event producer NF.

FIG. 8d is a block diagram showing an event consumer NF according to an embodiment of the disclosure. As shown, the event consumer NF 850 comprises a receiving module 851 configured to, when an occurrence of an exception of an event producer NF, receive a message comprising pending notification data from the event producer NF. First information may be used to indicate whether the event producer NF is required to send the pending notification data to the event consumer NF before handling the exception.

FIG. 8e is a block diagram showing a first NF according to another embodiment of the disclosure. As shown, the first NF 860 comprises a first receiving module 861 configured to receive a first notification message or a first unsubscription response comprising pending notification data from a third NF. The first notification message may further comprise second information indicating a cause of notification of the pending notification data.

In an embodiment, the first NF 860 may further comprise a first sending module 862 configured to send, to the third NF, a first notification response message comprising information indicating if the consumer instance will retrieve stored data or analytics prior to deletion.

In an embodiment, the first NF 860 may further comprise a second sending module 863 configured to send a second notification message or a second unsubscription response comprising the pending notification data to a second NF. The second notification message may further comprise the second information indicating the cause of notification of the pending notification data.

In an embodiment, the first NF 860 may further comprise a second receiving module 864 configured to receive, from the second NF, a second notification response message comprising information indicating if the consumer instance will retrieve stored data or analytics prior to deletion.

FIG. 8f is a block diagram showing a third NF according to another embodiment of the disclosure. As shown, the third NF 870 comprises a sending module 871 configured to send a first notification message or a first unsubscription response comprising pending notification data to a first NF. The first notification message may further comprise second information indicating a cause of notification of the pending notification data.

In an embodiment, the third NF 870 may further comprise a receiving module 872 configured to receive, from the first NF, a first notification response message comprising information indicating if the consumer instance will retrieve stored data or analytics prior to deletion.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the first NF, the second NF, the third NF or the event consumer NF may not need a fixed processor or memory, any computing resource and storage resource may be arranged from the first NF, the second NF, the third NF or the event consumer NF in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

Embodiment 1. A method (300) performed by a first network function (NF), comprising:
receiving (302) a first subscribe request from a second NF, wherein the first subscribe request comprises first information indicating whether an event producer NF is required to send pending notification data to an event consumer NF before handling an exception.

Embodiment 2. The method according to embodiment 1, wherein the first information comprises a pending notification flag.

Embodiment 3. The method according to embodiment 2, wherein
when the pending notification flag is set as true, it indicates that the event producer NF is required to send the pending notification data to the event consumer NF before handling the exception, and/or
when the pending notification flag is set as false or not present, it indicates that the event producer NF is not required to send the pending notification data to the event consumer NF before handling the exception.

Embodiment 4. The method according to any of embodiments 1-3, wherein the exception comprises at least one of:
the event producer NF cannot handle analytics,
the event producer NF cannot handle event data,
the event producer NF receives an unsubscription request,
the event producer NF decides to send a termination request,
event data cannot be collected,
subscription is transferred,
DCCF cannot handle the analytics data or collected data, or
aggregator NWDAF cannot handle the analytics.

Embodiment 5. The method according to any of embodiments 1-4, wherein the pending notification data comprises at least one stored unsent event.

Embodiment 6. The method according to any of embodiments 1-5, further comprising:
sending (312) a second subscribe request to a third NF, wherein the second subscribe request comprises the first information.

Embodiment 7. The method according to embodiment 6, further comprising:
when an occurrence of the exception of the event producer NF, receiving (322) a first message comprising the pending notification data from the third NF; and
sending (324) a second message comprising the pending notification data to the second NF.

Embodiment 8. The method according to embodiment 7, wherein the first message and/or the second message further comprises second information indicating a cause of notification of the pending notification data.

Embodiment 9. The method according to embodiment 8, wherein the cause of notification of the pending notification data comprises at least one of:
an exception occurs in the event producer NF,
the event producer NF cannot handle analytics,
the event producer NF cannot handle event data,
the event producer NF receives an unsubscription request,
the event producer NF decides to send a termination request,
event data cannot be collected,
subscription is transferred,
DCCF cannot handle the analytics data or collected data, or
aggregator NWDAF cannot handle the analytics.

Embodiment 10. The method according to any of embodiments 7-9, wherein the first message and/or the second message comprises at least one of:
a notification message, or
an unsubscription response.

Embodiment 11. The method according to embodiment 10, wherein the notification message comprises at least one of:
a data management notification message,
an analytics subscription notification message, or
an event exposure notification message.

Embodiment 12. The method according to embodiment 10 or 11, wherein the notification message comprises a termination request.

Embodiment 13. The method according to any of embodiments 6-12, wherein the second subscribe request comprises at least one of:
a data management subscribe request,
an analytics subscribe request, or
an event exposure subscribe request.

Embodiment 14. The method according to any of embodiments 6-13, wherein the third NF comprises at least one of:
an analytics data repository function (ADRF),
an aggregator NWDAF,
a data collection coordination (DCCF),
a network data analytics function (NWDAF),
a network exposure function (NEF),
an access and mobility management function (AMF),
a session management function (SMF),
a unified data management (UDM),
a network slice admission control function (NSACF),
an application function (AF),
a policy control function (PCF), or
a user plane function (UPF).

Embodiment 15. The method according to any of embodiments 1-5, further comprising:
determining (332) an occurrence of the exception; and
sending (334) a third message comprising the pending notification data to the second NF or the event consumer NF based on the first information.

Embodiment 16. The method according to embodiment 15, wherein the third message further comprises third information indicating a cause of notification of the pending notification data.

Embodiment 17. The method according to embodiment 16, wherein the cause of notification of the pending notification data comprises at least one of:
an exception occurs in the event producer NF,
the event producer NF cannot handle analytics,
the event producer NF cannot handle event data,
the event producer NF receives an unsubscription request,
the event producer NF decides to send a termination request,
event data cannot be collected,
subscription is transferred,
DCCF cannot handle the analytics data or collected data, or
aggregator NWDAF cannot handle the analytics.

Embodiment 18. The method according to any of embodiments 15-17, wherein the third message comprises at least one of:
a notification message, or
an unsubscription response.

Embodiment 19. The method according to embodiment 18, wherein the notification message comprises at least one of:
a data management notification message,
an analytics subscription notification message, or
an event exposure notification message.

Embodiment 20. The method according to embodiment 18 or 19, wherein the notification message comprises a termination request.

Embodiment 21. The method according to any of embodiments 1-20, wherein the first subscribe request comprises at least one of:
a data management subscribe request,
an analytics subscribe request, or
an event exposure subscribe request.

Embodiment 22. The method according to any of embodiments 1-21, wherein at least one of the first NF or the second NF or the event producer NF or the event consumer NF comprises at least one of:
an analytics data repository function (ADRF),
an aggregator NWDAF,
a data collection coordination (DCCF),
a network data analytics function (NWDAF),
a network exposure function (NEF),
an access and mobility management function (AMF),
a session management function (SMF),
a unified data management (UDM),
a network slice admission control function (NSACF),
an application function (AF),
a policy control function (PCF), or
a user plane function (UPF).

Embodiment 23. A method (400) performed by a second network function (NF), comprising:
sending (402) a first subscribe request to a first NF, wherein the first subscribe request comprises first information indicating whether an event producer NF is required to send pending notification data to an event consumer NF before handling an exception.

Embodiment 24. The method according to embodiment 23, wherein the first information comprises a pending notification flag.

Embodiment 25. The method according to embodiment 24, wherein
when the pending notification flag is set as true, it indicates that the event producer NF is required to send the pending notification data to the event consumer NF before handling the exception, and/or
when the pending notification flag is set as false or not present, it indicates that the event producer NF is not required to send the pending notification data to the event consumer NF before handling the exception.

Embodiment 26. The method according to any of embodiments 23-25, wherein the exception comprises at least one of:
the event producer NF cannot handle analytics,
the event producer NF cannot handle event data,
the event producer NF receives an unsubscription request,
the event producer NF decides to send a termination request,
event data cannot be collected,
subscription is transferred,
DCCF cannot handle the analytics data or collected data, or
aggregator NWDAF cannot handle the analytics.

Embodiment 27. The method according to any of embodiments 23-26, wherein the pending notification data comprises at least one stored unsent event.

Embodiment 28. The method according to any of embodiments 23-27, further comprising:

when an occurrence of the exception of the event producer NF, receiving (412) a message comprising the pending notification data from the first NF or the event producer NF.

Embodiment 29. The method according to embodiment 28, wherein the message further comprises fourth information indicating a cause of notification of the pending notification data.

Embodiment 30. The method according to embodiment 29, wherein the cause of notification of the pending notification data comprises at least one of:
an exception occurs in the event producer NF,
the event producer NF cannot handle analytics,
the event producer NF cannot handle event data,
the event producer NF receives an unsubscription request,
the event producer NF decides to send a termination request,
event data cannot be collected,
subscription is transferred,
DCCF cannot handle the analytics data or collected data, or
aggregator NWDAF cannot handle the analytics.

Embodiment 31. The method according to any of embodiments 28-30, wherein the message comprises at least one of:
a notification message, or
an unsubscription response.

Embodiment 32. The method according to embodiment 31, wherein the notification message comprises at least one of:
a data management notification message,
an analytics subscription notification message, or
an event exposure notification message.

Embodiment 33. The method according to embodiment 31 or 32, wherein the notification message comprises a termination request.

Embodiment 34. The method according to any of embodiments 23-33, wherein the first subscribe request comprises at least one of:
a data management subscribe request,
an analytics subscribe request, or
an event exposure subscribe request.

Embodiment 35. The method according to any of embodiments 23-34, wherein at least one of the first NF or the second NF or the event producer NF or the event consumer NF comprises at least one of:
an analytics data repository function (ADRF),
a data collection coordination (DCCF),
a network data analytics function (NWDAF),
a network exposure function (NEF),
an access and mobility management function (AMF),
a session management function (SMF),
a unified data management (UDM),
a gateway mobile location center (GMLC),
a network slice admission control function (NSACF),
an application function (AF),
a service communication proxy (SCP),
a policy control function (PCF), or
a user plane function (UPF).

Embodiment 36. A method (500) performed by an event consumer NF, comprising:
when an occurrence of an exception of an event producer NF, receiving (502) a message comprising pending notification data from the event producer NF,
wherein first information is used to indicate whether the event producer NF is required to send the pending notification data to the event consumer NF before handling the exception.

Embodiment 37. The method according to embodiment 36, wherein the first information comprises a pending notification flag.

Embodiment 38. The method according to embodiment 37, wherein
when the pending notification flag is set as true, it indicates that the event producer NF is required to send the pending notification data to the event consumer NF before handling the exception, and/or
when the pending notification flag is set as false or not present, it indicates that the event producer NF is not required to send the pending notification data to the event consumer NF before handling the exception.

Embodiment 39. The method according to any of embodiments 36-38, wherein the exception comprises at least one of:
the event producer NF cannot handle analytics,
the event producer NF cannot handle event data,
the event producer NF receives an unsubscription request,
the event producer NF decides to send a termination request,
event data cannot be collected,
subscription is transferred,
DCCF cannot handle the analytics data or collected data, or
aggregator NWDAF cannot handle the analytics.

Embodiment 40. The method according to any of embodiments 36-39, wherein the pending notification data comprises at least one stored unsent event.

Embodiment 41. The method according to any of embodiments 36-40, wherein the message further comprises fifth information indicating a cause of notification of the pending notification data.

Embodiment 42. The method according to embodiment 41, wherein the cause of notification of the pending notification data comprises at least one of:
an exception occurs in the event producer NF,
the event producer NF cannot handle analytics,
the event producer NF cannot handle event data,
the event producer NF receives an unsubscription request,
the event producer NF decides to send a termination request,
event data cannot be collected, or
subscription is transferred.

Embodiment 43. The method according to any of embodiments 36-42, wherein the message comprises at least one of:
a notification message, or
an unsubscription response.

Embodiment 44. The method according to embodiment 43, wherein the notification message comprises at least one of:
a data management notification message,
an analytics subscription notification message, or
an event exposure notification message.

Embodiment 45. The method according to embodiment 43 or 44, wherein the notification message comprises a termination request.

Embodiment 46. The method according to any of embodiments 36-45, wherein the event producer NF or the event consumer NF comprises at least one of:
an analytics data repository function (ADRF),
an aggregator NWDAF,
a data collection coordination (DCCF),
a network data analytics function (NWDAF),
a network exposure function (NEF),
an access and mobility management function (AMF),
a session management function (SMF),
a unified data management (UDM),
a network slice admission control function (NSACF),
an application function (AF),
a policy control function (PCF), or
a user plane function (UPF).

Embodiment 47. A first NF (800), comprising:
a processor (821); and
a memory (822) coupled to the processor (821), said memory (822) containing instructions executable by said processor (821), whereby said first NF (800) is operative to:
receive a first subscribe request from a second NF, wherein the first subscribe request comprises first information indicating whether an event producer NF is required to send pending notification data to an event consumer NF before handling an exception.

Embodiment 48. The first NF according to embodiment 47, wherein the first NF is further operative to perform the method of any one of embodiments 2 to 22.

Embodiment 49. A second NF (800), comprising:
a processor (821); and
a memory (822) coupled to the processor (821), said memory (822) containing instructions executable by said processor (821), whereby said second NF (800) is operative to:
send a first subscribe request to a first NF, wherein the first subscribe request comprises first information indicating whether an event producer NF is required to send pending notification data to an event consumer NF before handling an exception.

Embodiment 50. The second NF according to embodiment 49, wherein the second NF is further operative to perform the method of any one of embodiments 24 to 35.

Embodiment 51. An event consumer NF (800), comprising:
a processor (821); and
a memory (822) coupled to the processor (821), said memory (822) containing instructions executable by said processor (821), whereby said event consumer NF (800) is operative to:
when an occurrence of an exception of an event producer NF, receiving a message comprising pending notification data from the event producer NF,
wherein first information is used to indicate whether the event producer NF is required to send the pending notification data to the event consumer NF before handling the exception.

Embodiment 52. The event consumer NF according to embodiment 51, wherein the event consumer NF is further operative to perform the method of any one of embodiments 37 to 46.

Embodiment 53. A computer-readable storage medium storing instructions which when executed by at least one processor, cause the at least one processor to perform the method according to any one of embodiments 1 to 46.

Embodiment 54. A computer program product comprising instructions which when executed by at least one processor, cause the at least one processor to perform the method according to any one of embodiments 1 to 46.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a first network function (NF), comprising:
receiving a first notification message or a first unsubscription response comprising pending notification data from a third NF,
wherein the first notification message further comprises second information indicating a cause of notification of the pending notification data.

2. The method according to claim 1, wherein the first notification message further comprises information notifying a consumer instance when data or analytics is to be deleted.

3. The method according to claim 2, further comprising:
sending, to the third NF, a first notification response message comprising information indicating if the consumer instance will retrieve stored data or analytics prior to deletion.

4. The method according to any of claim 1, further comprising:
sending a second notification message or a second unsubscription response comprising the pending notification data to a second NF,
wherein the second notification message further comprises the second information indicating the cause of notification of the pending notification data.

5. The method according to claim 4, wherein the second notification message further comprises information notifying a consumer instance when data or analytics is to be deleted.

6. The method according to claim 5, further comprising:
receiving, from the second NF, a second notification response message comprising information indicating if the consumer instance will retrieve stored data or analytics prior to deletion.

7. The method according to claim 4, wherein the first NF and/or the second NF comprises at least one of:
an analytics data repository function (ADRF),
an aggregator NWDAF,
a data collection coordination (DCCF),
a network data analytics function (NWDAF),
a network exposure function (NEF),
an access and mobility management function (AMF),
a session management function (SMF),
a unified data management (UDM),
a network slice admission control function (NSACF),
an application function (AF),
a policy control function (PCF), or
a user plane function (UPF).

8. The method according to claim 1, wherein the cause of notification of the pending notification data comprises at least one of:
an exception occurs in the event producer NF,
the event producer NF cannot handle analytics,
the event producer NF cannot handle event data,
the event producer NF receives an unsubscription request,
the event producer NF decides to send a termination request,
event data cannot be collected,
subscription is transferred,
DCCF cannot handle the analytics data or collected data, or
aggregator NWDAF cannot handle the analytics.

9. The method according to claim 1, wherein the notification message comprises at least one of:
a data management notification message,
an analytics subscription notification message, or
an event exposure notification message.

10. The method according to claim 1, wherein the notification message comprises a termination request.

11. The method according to claim 1, wherein the third NF comprises at least one of:
an analytics data repository function (ADRF),
an aggregator NWDAF,
a data collection coordination (DCCF),
a network data analytics function (NWDAF),
a network exposure function (NEF),
an access and mobility management function (AMF),
a session management function (SMF),
a unified data management (UDM),
a network slice admission control function (NSACF),
an application function (AF),
a policy control function (PCF), or
a user plane function (UPF).

12. A method performed by a third network function (NF), comprising:
sending a first notification message or a first unsubscription response comprising pending notification data to a first NF,
wherein the first notification message further comprises second information indicating a cause of notification of the pending notification data.

13. The method according to claim 12, wherein the first notification message further comprises information notifying a consumer instance when data or analytics is to be deleted.

14. The method according to claim 13, further comprising:
receiving, from the first NF, a first notification response message comprising information indicating if the consumer instance will retrieve stored data or analytics prior to deletion.

15. The method according to claim 12, wherein the first NF comprises at least one of:
an analytics data repository function (ADRF),
an aggregator NWDAF,
a data collection coordination (DCCF),
a network data analytics function (NWDAF),
a network exposure function (NEF),
an access and mobility management function (AMF),
a session management function (SMF),
a unified data management (UDM),
a network slice admission control function (NSACF),
an application function (AF),
a policy control function (PCF), or
a user plane function (UPF).

16. The method according to claim 12, wherein the cause of notification of the pending notification data comprises at least one of:
an exception occurs in the event producer NF,
the event producer NF cannot handle analytics,
the event producer NF cannot handle event data,
the event producer NF receives an unsubscription request,
the event producer NF decides to send a termination request,
event data cannot be collected,
subscription is transferred,
DCCF cannot handle the analytics data or collected data, or
aggregator NWDAF cannot handle the analytics.

17. The method according to claim 12, wherein the notification message comprises at least one of:
a data management notification message,
an analytics subscription notification message, or
an event exposure notification message.

18. The method according to claim 12, wherein the notification message comprises a termination request.

19. The method according to claim 12, wherein the third NF comprises at least one of:
an analytics data repository function (ADRF),
an aggregator NWDAF,
a data collection coordination (DCCF),
a network data analytics function (NWDAF),
a network exposure function (NEF),
an access and mobility management function (AMF),
a session management function (SMF),
a unified data management (UDM),
a network slice admission control function (NSACF),
an application function (AF),
a policy control function (PCF), or
a user plane function (UPF).

20. A first NF, comprising:
a processor; and
a memory coupled to the processor, said memory containing instructions executable by said processor, whereby said first NF is operative to:
receive a first notification message or a first unsubscription response comprising pending notification data from a third NF,
wherein the first notification message further comprises second information indicating a cause of notification of the pending notification data.

21. The first NF according to claim 20, wherein the first NF is further operative to perform the method comprising:
receiving a first notification message or a first unsubscription response comprising pending notification data from a third NF,
wherein the first notification message further comprises second information indicating a cause of notification of the pending notification data, wherein the first notification message further comprises information notifying a consumer instance when data or analytics is to be deleted.

22. A third NF, comprising:
a processor; and
a memory coupled to the processor, said memory containing instructions executable by said processor, whereby said third NF is operative to:
send a first notification message or a first unsubscription response comprising pending notification data to a first NF,
wherein the first notification message further comprises second information indicating a cause of notification of the pending notification data.

23. The third NF according to claim 22, wherein the third NF is further operative to perform the method comprising:
sending a first notification message or a first unsubscription response comprising pending notification data to a first NE,
wherein the first notification message further comprises second information indicating a cause of notification of the pending notification data,
wherein the first notification message further comprises information notifying a consumer instance when data or analytics is to be deleted.

24. A computer-readable storage medium storing instructions which when executed by at least one processor, cause the at least one processor to perform the method according to claim 1.

25. (canceled)
